(19) United States
(12) Patent Application Publication
(10) Pub. No.: US 2005/0261804 A1
(43) Pub. Date: Nov. 24, 2005

(54) Mechanical lock manipulation device and method

(76) Inventors: John Doty, Lexington, KY (US); Gerald L. Dawson, New Port Richey, FL (US); Carl Cole, Lexington, KY (US)

Correspondence Address: ARENT FOX PLLC, 1050 CONNECTICUT AVENUE, N.W., SUITE 400, WASHINGTON, DC, 20036, US

(21) Appl. No.: 10/850,557

(22) Filed: May 21, 2004

(51) Int. Cl. E05B 17/00

(52) U.S. Cl. 700/275; 70/446

(57) ABSTRACT

The present invention is a mechanical lock manipulator and method of manipulating mechanical locks. There is a computer or microprocessor that controls a motor. The motor rotates the dial of a mechanical lock either clockwise or counterclockwise as directed by the computer. The computer receives an input from a transducer mounted to the lock or container. The transducer converts sounds and/or vibrations, into electrical signals. The computer collects data from the transducer and then evaluates this data and determines the opening combination for the lock.

### BACKGROUND OF THE INVENTION

1. Field of the Invention

This invention relates generally to devices and methods used to manipulate, decode, or otherwise determine the combination to a mechanical lock and more particularly to automatic electronic devices and methods utilized to determine the combination for a mechanical lock.

2. Description of the Prior Art

A safe, vault, or other security container is often secured by a mechanical combination lock. Occasionally, the person(s) authorized to open the lock forget, lose, or are otherwise unable to obtain the correct combination. Under these circumstances the lock and/or security container may be drilled to open the lock and the container, however, at the least the lock is destroyed in the process. Typically, there is also some damage to the security container. Consequently, the security of the container is also reduced in this process. Thus, a locksmith may be employed to determine the locks combination so that the container may be opened without damaging the lock or the container.

The time taken by a particular locksmith to determine the combination for a particular lock depends on the skill and proficiency of the locksmith employed for the task. In order to assist the locksmith or reduce the skill needed by a locksmith several devices and methods have been developed.

U.S. Pat. No. 4,433,563 issued to Wilson on Feb. 28, 1984 discloses a Lock Decoder that is capable of automatically dialing combinations until the opening combination is found. This device is dependent on rapidly dialing different combinations with an electric stepper motor controlled typically by a computer.

U.S. Pat. No. 4,803,860 issued to Moore on Feb. 14, 1989 describes a method and apparatus for reducing the skill required by the locksmith using the manipulation method to determine the correct combination. Clyde Lentz and Bill Kenton present a detailed description of this method in The Art of Manipulation (1959). This device requires the locksmith to setup and adjust the device. Additionally, the locksmith must still rotate the lock's dial. Therefore, time required to discover the lock's combination is still dependent on the locksmith.

U.S. Pat. No. 4,905,490 issued to Wilson on Mar. 6, 1990 describes an automatic device that uses the manipulation method to find the combination to a mechanical combination lock. This device utilizes a high-resolution encoder to determine the dial's position when the transducer detects a contact point. Unfortunately, high-resolution encoders are expensive and increase the cost of the device.

Therefore, a mechanical lock manipulation device and method are needed that do not require a high-resolution encoder and permit a locksmith to find the combination to a container secured by a mechanical lock that is susceptible to manipulation.

### SUMMARY OF THE INVENTION

The present invention has solved the problems cited above, and comprises broadly a mechanical lock manipulator and method. There is a computer that controls a motor. The motor rotates the dial of a mechanical lock either clockwise or counterclockwise as directed by the computer. The computer receives an input from a transducer mounted to the lock or container. The computer collects data from the transducer and then evaluates this data and determines the opening combination for the lock.

### BRIEF DESCRIPTION OF THE DRAWINGS

The accompanying drawings incorporated in and forming part of the specification illustrates several aspects of the present invention, and together with the description serve to explain the principles of the invention in the drawings:

FIG. 1 is a functional block diagram for a manipulator in accordance with a first embodiment of the present invention;

FIG. 2 is a diagram illustrating the motor attached to a container having a mechanical lock;

FIG. 3 is one functional flow diagram for the first embodiment of the manipulator logic;

FIG. 4 is a detailed flow diagram representing the wheel analysis logic that may be utilized in the logic shown in FIG. 3;

FIG. 5 is an exemplary flow diagram representing the data analysis logic that may be utilized in the wheel analysis logic shown in FIG. 4;

FIG. 6 illustrates exemplary program logic for a program that employs routines developed for specific locks;

FIG. 7 illustrates the program flow for S&G 6730 method 1;

FIG. 8 illustrates the program flow for S&G 6730 method 2, LaGard 3330 method 1 and method 2;

FIG. 9 illustrates the program flow for IIco 673 method 1;

FIG. 10 illustrates the program flow for IIco 673 method 2;

FIG. 11 is a detailed flow diagram representing the wheel analysis logic utilized in the logic shown in FIGS. 7, 8, 9, and 10;

FIG. 12 is detailed flow diagram representing the data analysis logic;

FIG. 13 illustrates an exemplary setup screen that may be utilized as an operator aid;

FIG. 14 illustrates an exemplary review window with dialog box that may be employed as an operator aid;

FIG. 15 illustrates an exemplary wheel-processing window that may be utilized to show the progress and status of the manipulator;

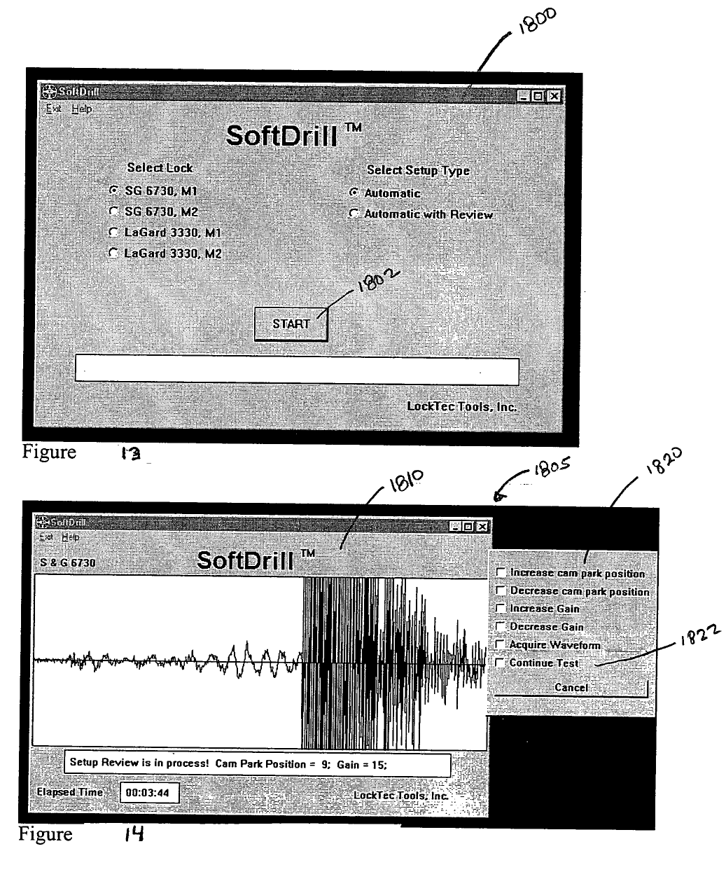

FIG. 16 illustrates an exemplary ready to end program window that may indicate that the manipulator has determined the combination to the lock;

FIG. 17 provides a functional block diagram of a second embodiment of the present invention;

FIG. 18 illustrates a block diagram of program execution for the second embodiment;

FIG. 19 illustrates details of wheel analysis routines for the second embodiment; and

FIG. 20 illustrates an exemplary data analysis routine for the second embodiment of the present invention.

Reference will be now be made in detail to two embodiments of the invention, examples of which are illustrated in the accompanying drawings.

### DETAILED DESCRIPTION OF THE INVENTION

Overview

The basic idea behind a manipulator is to determine the access code or combination for a mechanical lock by analyzing the sound and/or vibrations produced and/or transmitted by the lock to a sensor located outside the area controlled/secured by the lock. Two basic approaches can be taken: (1) listening to the sound and/or vibrations produced by the lock, typically, the sound of the lever contacting the cam and/or the fence contacting the wheel pack; and/or (2) listening to the sound and/or vibrations transmitted through the lock from a known source. Each approach may be utilized independently or may be combined.

The simplest approach or Group II approach listens for sounds and/or vibrations generated internally to the lock. The Group II approach is effective at determining the combination for mechanical locks where a lever rides on a cam with a notch (drop region) and/or a fence rides on the wheel pack.

The basic idea behind the Group II approach is to listen for sounds generated internally within the lock. Specifically, a transducer may be used to detect the mechanical sounds and/or vibrations produced by bringing the cam into contact with the lever after the lever is located in a detent region of the cam. This is known as the contact point, or as the “click.” Starting the cam from a known position and then moving the cam toward the contact point at a known rate gives an indication of the angle at which the fence meets the wheel(s). The height of the wheel(s) at the fence rest location is indicated by the time it takes to move the cam from its start position to the contact point. A know cam start position and known acceleration and velocity settings utilized for motor movement and hence the cam movement are assumed. By moving the wheel(s) under the fence and taking contact point readings at various locations about the wheel, a representation of the shape or profile of the wheel(s) is obtained. The wheel profile gives away the gate location. When this is done for each of the wheels, the combination of the lock may be obtained. Alternatively, the transducer may detect the mechanical sounds and/or vibrations produced by bringing the fence into contact with the wheel pack after the nose of the lever is located in a detent or drop region of the cam.

In some locks the detent region of the cam is masked in an effort to prevent the lock from being opened by manipulation. One example of this type of lock is the Chatwood Milner (CM) lock. This lock employs a two-part cam to mask the cam detent.

The basic idea behind the approach taken for manipulation of the CM lock is that by exciting the lock at a specific frequency or over a range of specific frequencies and measuring the response of the lock to this excitation, one is able to obtain information about the shape of the wheels, i.e. the profile of the wheels. The profile information is used to determine the location of the wheel gates. Knowing even two of three wheels greatly reduce the time required to open the lock, as the unknown wheel can be auto-dialed. By obtaining profiles for each wheel, one can determine the gate locations, which give the combination of the lock.

In other locks, the lever is held out of contact with the cam until the combination is entered. One example of this type of lock is the S & G 8550. The operation of this lock is discussed in detail in U.S. Pat. No. 3,968,667 entitled combination lock construction.

It is expected that methods similar to those discussed for the Group II and/or CM locks could be developed where the manipulator measures the time it takes the lever and fence to fall from the raised disengaged position to the position where the fence rides on or makes contact with the wheel pack and/or the magnitude and frequency of the sound/vibration produced by the fence making contact with the wheel pack. Due to the short times/distances involved higher sample rates may be required to obtain data with enough variation to be significant.

Group II Hardware

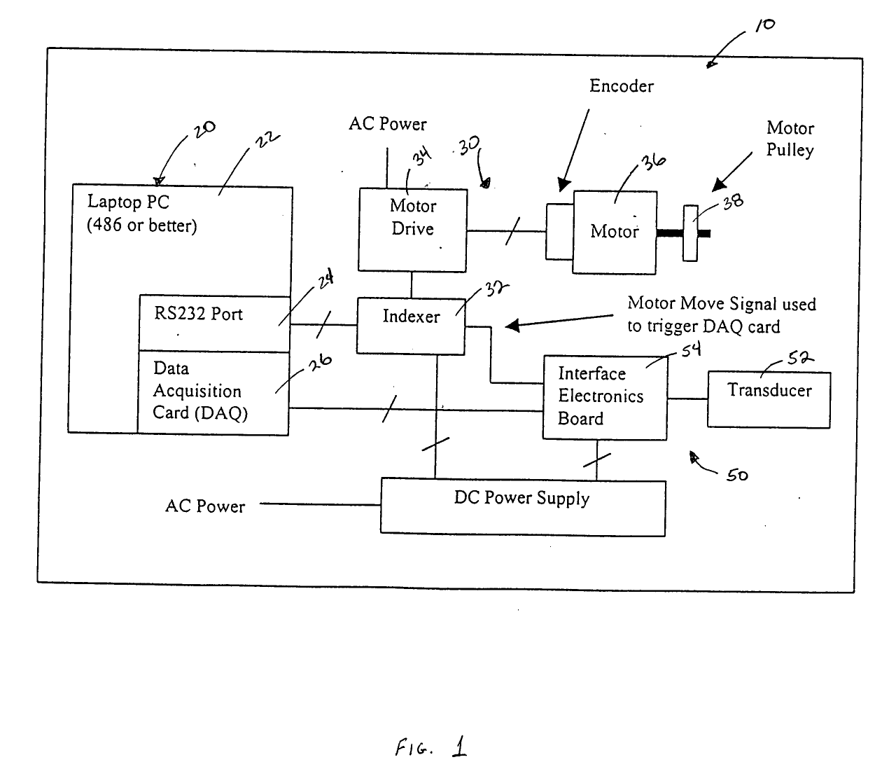

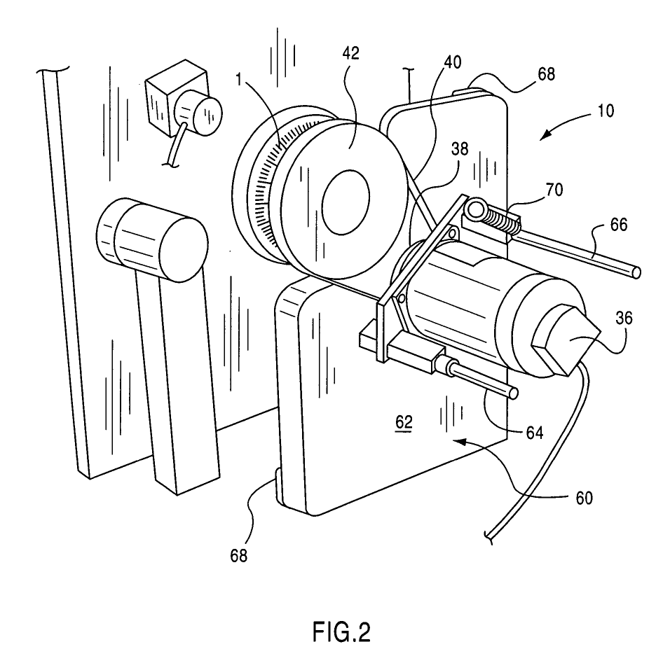

FIG. 1 illustrates a block diagram of an embodiment of automatic manipulator 10 that may be employed to open Group II mechanical locks. This device uses a computer 20 to control a motor system 30 that rotates the dial 1 of a mechanical combination lock (FIG. 2). The computer 20 receives signals from sensor system 50. One of these signals may trigger computer 20 to start collecting “click” data and another signal provides the “click” data. The trigger signal may also be provided to computer 20 from motor system 20.

Computer

Computer 20 is typically a general-purpose computer 22 with a communications port 24 and either a data acquisition card 26 or an analog to digital converter. Alternatively, computer 20 may be a specially designed and/or programmed microprocessor with supporting electronics and/or interfaces to the motor system 30 and sensor system 50. In some embodiments the data acquisition card 26 or an analog to digital converter may be located externally from computer 20 and/or integrated with the sensor system 50.

Preferably, general-purpose computer 22 is a laptop or desktop computer utilizing at least an Intel® 486 or equivalent main processor. This preference is based on using a thirty-two bit operating system, Windows 95, 98, or NT. Other processors and operating systems could easily be used for general-purpose computer 22 if desired. An exemplary general-purpose computer 22 is a Gateway Solo 266 MHz Pentium II running Windows 95.

Communications port 24 may be any serial or parallel port compatible with the motor system 30. Typically, communications port 24 is a serial port utilizing the RS232 communications protocol.

Data acquisition card 26 may be any analog-to-digital (A/D) card or any data acquisition card that can accept and process the signal output from the sensor system 50. Additionally, card 26 must be compatible with the operating system on general-purpose computer 22 and the manipulation software running thereon. Preferably, card 26 is a data acquisition PCMCIA card that permits the computer to control the gain of the signal produced by the sensor system 50. An exemplary data acquisition card is the National Instruments DAQCard-AI-16E-4.

Motor System

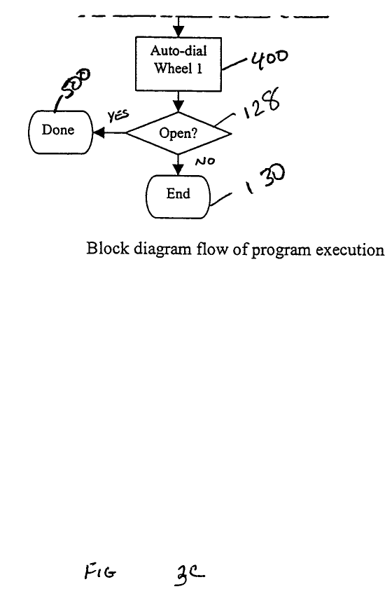

Motor system 30 rotates dial 1 an angular distance and direction determined by the control signal received from computer 20. Typically, motor system 30 employs indexer 32, motor drive 34, stepper motor 36, motor pulley 38, drive belt 40 (FIG. 5), and dial pulley 42 (FIG. 5). Indexer 32 converts the control signal from computer 20 into a motor control signal that when amplified by motor drive 34 rotates stepper motor 36 the desired number of motor steps (angular distance) in the desired direction. Indexer 32 may also control the velocity, acceleration, and/or acceleration profile of stepper motor 36. For an indexer 32 with this capability the control signal sent from computer 20 to indexer 32 would also provide these parameters as part of the control signal.

The combination of indexer 32, motor drive 34, and stepper motor 36 provide for accurate and repeatable positioning of dial 1. In some embodiments, motor system 20 positions dial 1 within at least one fortieth of a dial position. For some locks, a motor system 20 with lower resolution may be satisfactory. A satisfactory indexer 32 is a Parker Compumotor OEM010 stand-alone indexer. The exemplary motor drive 34 is a Parker Compumotor Zeta4 Drive. The stepper motor 36 may be an Applied Motion Products 5023-168D Step Motor. This stepper motor 36 provides twenty-five thousand steps per revolution or two hundred fifty steps per dial position when the stepper motor 36 rotates dial 1 in a one-to-one relationship. The motor selected utilizes micro-stepping to reduce motor vibration. Although a step motor is used in the current design, there is no reason why a servomotor or a DC motor could not be used. A step motor was chosen for economic reasons. The motor is used to actuate the lock dial for the purposes of positioning the lock wheels.

Motor 36 may rotate dial 1 utilizing any method that permits dial 1 to be positioned within the accuracy required for a particular lock. Preferably, there is a toothed motor pulley 38 connected to the drive shaft of stepper motor 36. There is also a correspondingly toothed dial pulley 42 that is removably mounted to dial 1. This mounting while removable prevents any significant movement between dial 1 and dial pulley 42. The preferred mounting employs at least two set screws that engage the dial 1. The threaded bore into which the set screws thread are offset by at least ten degrees from a line perpendicular to the surface of dial 1 at the point that the set screw contracts dial 1. This set screw arrangement limits the relative motion between the dial pulley 42 and dial 1.

Preferably, motor pulley 38 is drivingly connected to dial pulley 42 with drive belt 40. Drive belt 40 typically has teeth that match the teeth on pulleys 38 and 42. The use of a toothed drive belt minimizes the slippage between dial pulley 42 and motor pulley 38. To further aid in maintaining a direct correspondence between the dial 1 position and the stepper motor 36 position drive belt 40 is preferably selected with a short length and limited elasticity.

Examples of alternative devices employed to drivingly connect stepper motor 36 to dial 1 include but are not limited to, replacing pulleys 38, 42 and drive belt 40 with two or more gears or replacing molded pulleys 38, 42 and drive belt 40 with a molded cup joined to the shaft of motor 36 and engaging dial 1 with a friction or interference fit.

In the current embodiment stepper motor 36 is supported and positioned proximate dial 1 for the mechanical lock to be opened with stand 60. The preferred stand has a base 62 and two vertical supports 64 and 66. These supports 64 and 66 are both fastened or joined to base 62. The motor 36 is pivotally mounted to motor support 64. The motor 36 is also connected to the tension support 66 by tensioner 70. The tensioner 70 maintains a relativity constant tension in drive belt 40. A constant drive belt 40 tension aids in maintaining a direct correspondence between the dial 1 position and the stepper motor 36 position. Base 62 may be offset from the surface of the container to which the lock is mounted with one or more spacers 68. Spacers 68 may be used to position motor pulley 38 in approximately the same plane as dial pulley 42. Additionally, spacers 68 may enable the base 62 to be installed over and/or near any surface features of the container located proximate dial 1.

Sensor System

The sensor system 50 detects the vibrations and sounds produced by the lock. The only vibrations and/or sounds that are of interest are those produced while rotating dial 1. Thus, in the current embodiment a signal is sent from motor system 30 to the sensor system 50 when motor 36 is directed to move dial 1. This signal is utilized to trigger or start collecting the data and/or signals sensed by sensor system 50. In the current embodiment the sensor system 50 constantly detects vibrations and/or sounds produced by the lock. Thus, sensor system 50 retransmits or passes this signal to the data acquisition card 26 that controls the data collection.

The sensor system 50 typically, employs a transducer 52 to detect the vibrations and/or sounds produced by the lock. Transducer 52 provides a sensor signal to interface electronics 54. The interface electronics 54 typically amplify and condition the sensor signal into an analog signal that can be processed by computer 20. In some embodiments, interface electronics 54 may receive dc power from power supply 56. Alternatively, the interface electronics may have the required circuitry to convert ac to dc for use by the circuits requiring dc power.

A suitable transducer is a charge-mode piezoelectric accelerometer with a charge sensitivity of 100 pC/g. The interface electronics 54 may employ an amplifier that converts the transducer output to a voltage signal. Typically, the charge amplifier output is fed to an instrumentation amp. The instrumentation amp may contain a programmable gain selection. The preferred embodiment utilizes variable gains from one to at least forty, with some embodiments including gains from one to two hundred fifty-six. The overall amplification produced by interface electronics 54 should produce a signal that can be processed by computer 20. Preferably, the analog signal at the instrumentation amp output is at least +/−10 volts for the AT-MIO-16-E1 board and +/−5 volts for the DAQ Card 1200, the optimum voltage output from interface electronics 54, however, will depend on the data acquisition card 26 utilized.

As discussed above, it is desired that the data acquisition card 26 be capable of being triggered. Currently, the initiation of data acquisition is triggered with the step signal from the indexer 32, as this signal initiates the motor move with motor drive 34. This common trigger provides for obtaining data samples having a common reference point in time. Alternatively, the each data sample could be time stamped or time coded so that computer 20 could accomplish accurate timing or counting of the data samples.

Cm Hardware

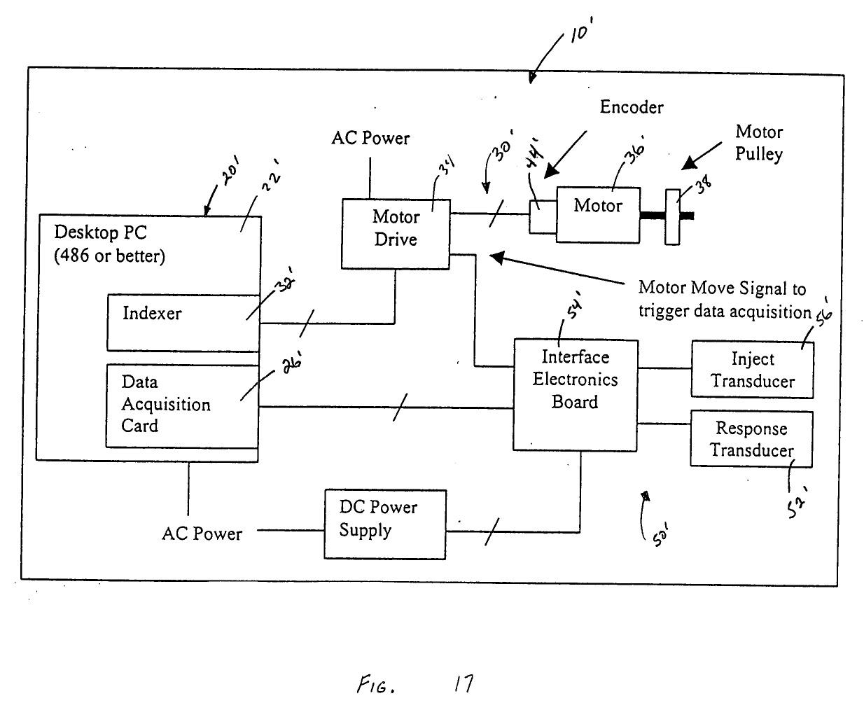

An exemplary functional block diagram of a second embodiment of manipulator 10′ is provided in FIG. 17. The second embodiment is similar to the first embodiment with the addition of an inject transducer 56′ and the employment of a desktop general purpose computer 22′ instead of a laptop computer 22 illustrated in FIG. 1. When a desktop computer 22′ is utilized the indexer 32′ may be installed into computer 22′ or a communication port 24 and external indexer 32 may be employed as illustrated in FIG. 1.

For example a. Pentium-class AT&T Globalyst 373TPC computer 22′ with an AT-MIO-16-E1 data acquisition board 26′ and associated software from National Instruments, an OEM23AT indexer 32′ which is used to control an external Zeta-4 Step Motor Drive 34, both of which are from Parker Compumotor, a 5023-168D step motor 36 from Applied Motion Products, an E2-100-250-HG 100 cycle/rev encoder 44′ from US Digital, a CSM23A-8 miniature speaker 56′ from Golden Pacific Electronics, a 353B33 charge-mode accelerometer 52′ from PCB Piezotronics, a lab-grade dual output power supply, an electronics interface board 54′, and a mechanical mounting assembly 60.

Software was developed that oversees the communication between the different components and the flow of data acquisition and analysis, including the algorithms that operate on the acquired data to determine candidate gate positions. The AT-MIO-16-E1 was chosen to provide sufficient sample rate and on board buffer size as well as analog output capabilities. Although the above-mentioned off-the-shelf components were chosen, there is no reason why equivalent components could not be used. A custom design of the electronics, which incorporates the necessary functionality of the above components, would also be possible.

Although a step motor is used in the current design, there is no reason why a servo motor or a DC motor could not be used. A step motor was chosen for economic reasons. The motor is used to actuate the lock dial for the purposes of positioning the lock wheels. This is achieved by way of a belt/pulley mechanism. The motor pulley 38 drives a pulley 42 that is attached directly to the lock dial 1. The reason a belt/pulley mechanism was chosen rather than a direct connection from motor 36 to lock dial 1 was due to the fact that the inject transducer 56′ also attaches to the lock dial 1. Using a pulley 42 on the dial 1 better facilitates attachment of the transducer 56′ to the dial 1. While the current approach uses wires to communicate with the inject transducer 56′, a mechanism whereby a battery powered IR-LED/detector pair, or a visible LED/detector pair, or other wireless technique could be used to communicate with the inject transducer 56′. The employment of a belt 40 tends to minimize transfer of motor noise to the lock. Additionally, a belt/pulley mechanism may better facilitate adaptability to a wide range of lock dial-types.

The inject transducer 56′ may be used to excite the lock at a given frequency or over a range of frequencies, i.e. to ‘inject’ the frequencies into the lock. In some versions of the manipulator, a piezo ceramic buzzer may also be employed to excite the lock. A custom inject transducer 56′ could also be designed specifically for the given application in order to improve the dynamic range and coupling of signal to the lock.

In order to measure the response of the lock, response transducer 52′ magnetically mounted to the container surface may be used. One example of transducer 52′ is a charge-mode accelerometer (357B33 from PCB Piezotronics). Use of a charge-mode accelerometer is only one of many methods of measuring the response. For example, an accelerometer having integrated electronics such as the ICP series of accelerometers from PCB Piezotronics could be used as well. More exotic methods such as reflected laser approaches, or transducers based on Micro-Electro-Mechanical-Systems (MEMS) technology could also be employed.

An interface board 54′ for signal conditioning is used to condition the response signal from the response transducer appropriately for sampling by the data acquisition card. This card performs a similar function to interface board 54 discussed above with the addition of the ability to drive the inject transducer 56′. The response signal is then used to determine a representative value for the given set of wheel park positions. When all representative values for a given wheel have been acquired, this data is fed to an algorithm, which determines the best candidate gate value as discussed more fully below.

Operation

By taking readings at equally spaced positions (though it is not absolutely necessary to have equal spacing between samples) covering the perimeter of the wheel, a representation of the wheel profile can be obtained. A subsequent analysis of this representation can be used to determine a candidate gate for the given wheel. When a candidate gate for the first wheel has been determined, this wheel is parked at its candidate gate position and the next wheel is analyzed in the same manner. It is often sufficient to obtain the combination of two wheels since the third wheel can be auto-dialed more quickly than data acquisition and analysis of the third wheel to determine its gate location. One could, however, choose to acquire data for the third wheel for analysis in the event that the candidate gate of one or both of the first two wheels was not correct. In this case, an iterative approach can be taken whereby a decision criterion is used to determine the next wheel to profile.

Sample Rate

The sample rate for the Group II approach is currently 20 kSamples/sec. There are a number of parameters that help decide the adequate sample rate for a given set of hardware. They include the size of the buffer used to store the acquired data, and the profile of the motor move, which includes the acceleration and velocity settings. The analog input buffer currently used holds 1024 samples. Thus, the sample rate of 20 kSamples/sec gives a time interval of 50 microseconds between samples, and the buffer can hold 51.2 milliseconds worth of data. The motor move command serves as a trigger for the analog input data acquisition. It was determined by experiment that positioning the cam approximately four dial positions from the contact point and moving the cam toward the contact point at predetermined acceleration and velocity settings would produce a click of sufficient strength to be picked up by the transducer. To move the cam four dial positions to the contact point requires approximately 30 milliseconds for the acceleration and velocity settings used in the current program. The spread of the click data using the current settings can be as much as 100 sample positions. At the 20 kHz sample frequency, 100 samples corresponds to five milliseconds of data. A safety margin of at least four times this value would give 20 milliseconds worth of data beyond the initial 30 milliseconds worth of data, giving a total of 50 milliseconds worth of data. For maximum resolution in the acquired signal using the current approach, the entire buffer should be filled with the 50 milliseconds worth of data, and this is currently what is done.

For a different set of parameters, i.e. the sample rate, buffer size, acceleration and velocity settings, one could certainly reduce the sample rate. The extent to which the sample rate could be reduced would depend primarily on the hardware used. It would be necessary to weigh the tradeoffs involving the acceptable resolution of the contact point values and the strength of the contact point signal. A slight modification of the current approach, for example, would add a time delay to the data acquisition trigger, and reduce the sample rate so as to expand a smaller window on the received data into the input buffer. Other techniques could include changing the acceleration and velocity settings in conjunction with the cam start position to contact point distance, etc.

Currently the acceleration and velocity settings sent to indexer 32 by computer 20 combined with a 20,000 sample per second sample rate by the data acquisition card 26 enable a resolution of approximately 50 samples per dial position at the contact point. It is preferable to have approximately 50 samples per dial position or greater as this increases the resolution of contact point values. There is tradeoff between the acceleration and velocity settings, the sample rate used, and the signal to noise ratio of the acquired signal. For example, a slower velocity at a given sample rate increases the samples per dial position resolution, but the signal to noise ratio may be decreased. Likewise a faster sample rate at given acceleration and velocity values also increases the samples per dial position resolution at the expense of increased buffer memory on the data acquisition card 26.

The sample rate of the analog input currently used in the CM lock manipulation program is 62.5 kSamples/sec. This has been shown to be sufficient for obtaining a sample of sufficient resolution to pull out a reliable FFT magnitude at the injected frequency for the CM approach. The Nyquist frequency for the highest inject frequency is 3.2 kHz. This is the theoretical minimum frequency above which the sample rate must be in order to faithfully reproduce the signal that is sampled. Note that this establishes the theoretical minimum sample rate. In order to faithfully capture the FFT magnitudes, however, at least ten times the Nyquist frequency is deemed sufficient. This gives a lower limit on the analog input sample rate of 32 kHz for the CM approach.

The rate at which the analog output waveform samples are output is currently 62.5 kHz. This has proven to be sufficient for the purposes of generating the waveforms that are applied to the inject transducer. However, by way of analogy with the analog input rate for the CM approach, this rate could be lowered to 32 kHz with no foreseeable consequences.

Wheel Order

The order in which the wheels are analyzed is important. This is due to the fact that the fence is typically tilted so as to favor one wheel more than the others. That is, the fence rarely rests evenly on the wheel pack. For most locks the outermost wheel is favored. Therefore, the logical choice for the first wheel to test (i.e. profile) is the outermost wheel. Once a candidate gate position has been determined for this wheel, this wheel is parked at its candidate gate position and the next wheel is tested. When a candidate gate position for the second wheel has been determined, the second wheel is parked at its candidate gate position. With the first and second wheels parked at their respective candidate gate positions, the third wheel is auto-dialed through its dial positions. If the gate candidates for the first two wheels are in fact the true gate positions, the lock will open when the third wheel reaches its gate position. As mentioned above, it is faster to auto-dial the third wheel than it is to collect and analyze the data. And it is unnecessary to profile the third wheel in the event that the lock opens. However, if either or both of the first two wheel candidate gate positions are incorrect, it would be useful to have the profile data for the third wheel in order to iterate through the wheels again.

Because most locks favor the outermost wheel, a pre-determined order for the wheels can be used. Alternatively, a test could be performed to determine the best order for the wheels to be tested. In this way, a decision criterion would be used to determine the order in which the wheels should be tested. By allowing both a pre-determined wheel order test and a decision based wheel order test, an iterative approach toward the determination of the lock combination could be implemented. That is, if a forced order test failed to open the lock, the program could switch to a decision based approach, which would include information gathered in the previous test(s). One could also envision a completely decision based approach which would iterate through the wheels until the lock opened. One advantage of iterating through the wheels is that previous wheel information would be stored and incorporated into the current and following wheel tests.

The order of wheel tests for the Group II locks depends on the lock type and method selected in the setup screen of the program. For example if a Sargent & Greenleaf 6730 lock is selected, and method 1 for this lock is selected, a forced wheel order is used. If method 2 had been chosen, the program determines the order of the wheel tests. These methods will be described in detail in the following sections.

Software Overview

In the following sections, flow charts are given that describe the flow of the program used to manipulate locks. It should be noted that the program logic and order of the wheel tests taken in the current program is only one of many approaches.

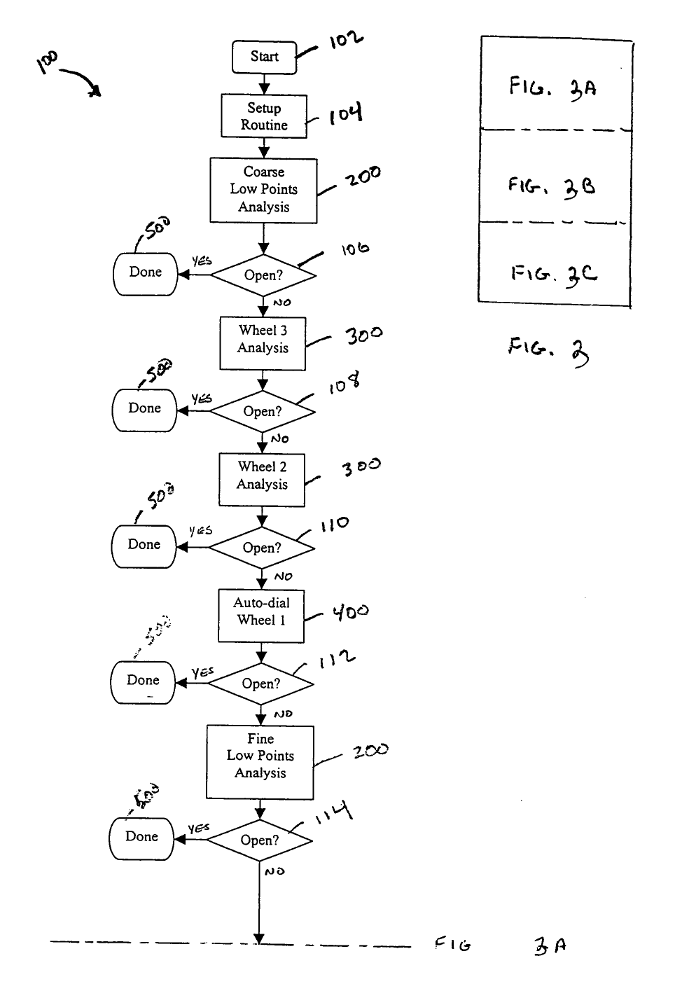

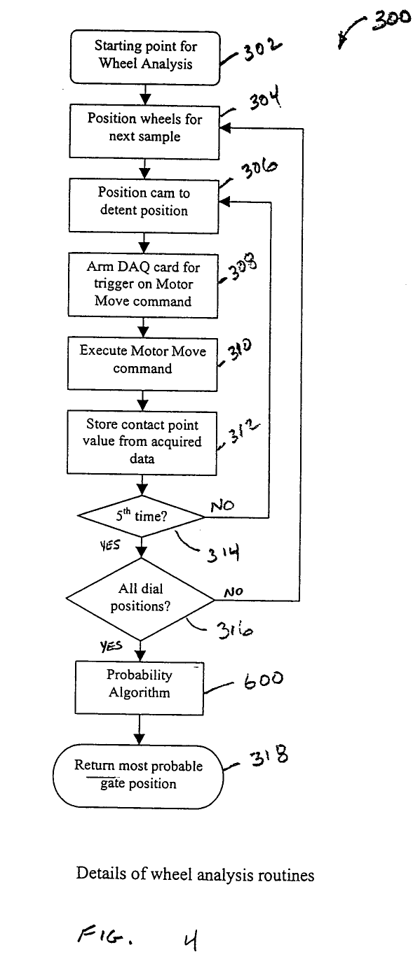

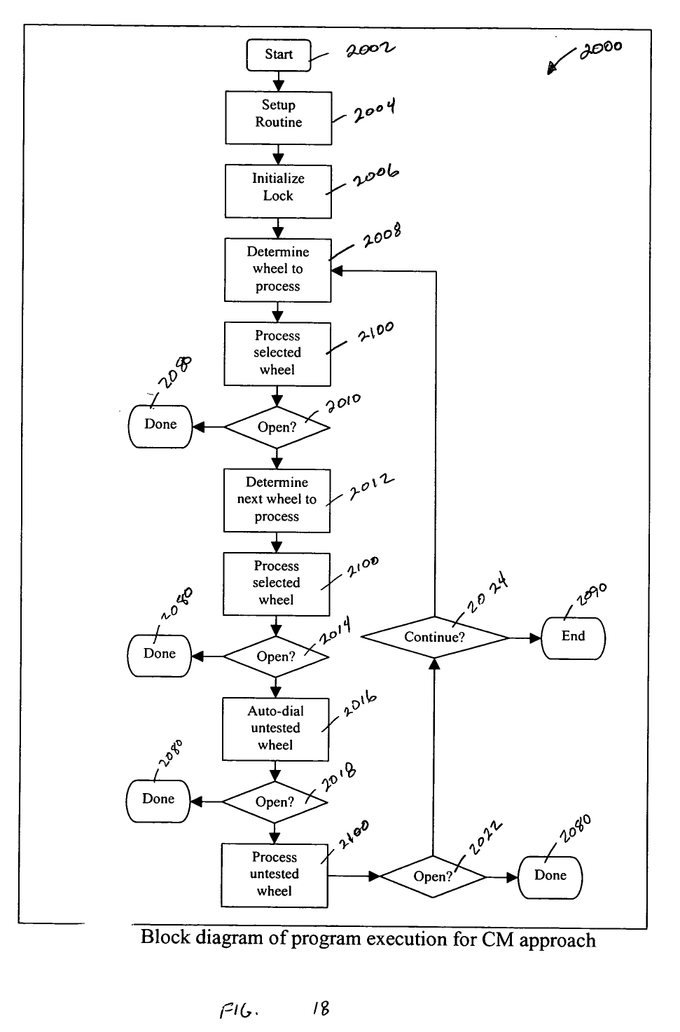

FIGS. 3 through 5 illustrate the functional logic for a program 100 that may be utilized by computer 20 to determine the most probable combination for the lock. FIGS. 6 through 12 provide exemplary programming logic for a program 1000 employing routines optimized for specific Group II locks. FIGS. 18 through 20 illustrate the programming logic that may be employed in the second embodiment of the invention that is capable of opening the CM lock.

Basic Program

Main Line Program

Program 100 illustrates the general approach that may be modified and/or optimized for a specific lock. The program 100 shown in FIG. 3 begins at start 102. Thereafter the logic flow moves to setup block 104 where the user may input information about the type of lock to be opened. This information may include lock type, location of the cam to fence-nose contact point, and transducer gain/placement settings.

Next, the logic flow moves to the low points analysis block 200 where a coarse analysis may be performed. The low points analysis determines the park positions for wheel two and wheel one of the lock. These park positions correspond to low points on wheel two and wheel one respectively and are used in wheel three analysis. Finding the low points on wheels two and one, while optional, increases the chance of finding the wheel three gate by minimizing the chance of masking the wheel three gate due to holding the fence off wheel three by parking wheel two or wheel one at a high point. In order to find good park positions for wheel two and wheel one, contact points are found for a number of combinations.

The coarse low points analysis uses fewer combinations than the fine low points analysis. Thus, the coarse low points analysis covers fewer positions on the wheels. The trade-off between the coarse and the fine low points analyses involves resolution of positions tested versus time to complete the analysis. After dialing each combination, the lock is checked to see if the lock will open. If the lock opens then a flag, interrupt, or other indicator may be set. Preferably, the low point analysis would terminate if the lock opened. After the lock opened or the course low point analysis was complete the program flow moves to decision block 106. Decision block 106 checks to see if the lock opened. If the lock opened, then the logic flow may move to done terminator 500.

When the lock is not open, the logic flow continues to wheel analysis 300 for wheel three. The wheel analysis obtains the contact point values for one wheel with the remaining two wheels in the park position. The wheel three analysis is preformed with wheel two and wheel one in the park position. The park positions are determined either by a low point analysis and/or previous wheel two and/or wheel one analysis.

Wheel Analysis

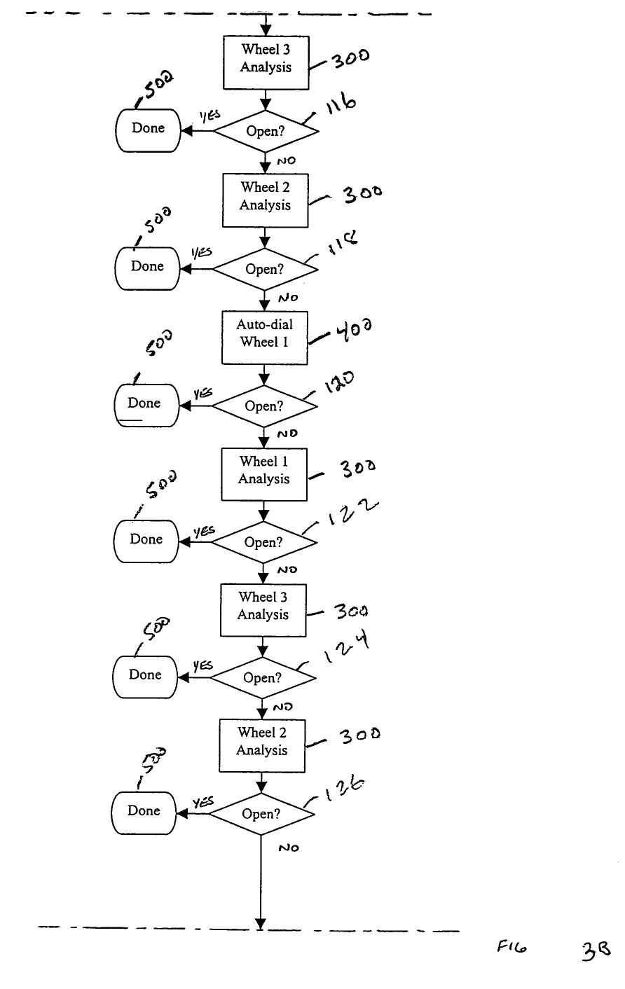

FIG. 4 illustrates the details for the wheel analysis routine 300. In this routine contact point values are acquired for incremental steps over the valid range of wheel combinations. The preferred increment is one dial position, but could be up to two dial positions. Preferably, multiple contact point values are acquired at each dial position tested. These values are then processed by a selection function that throws away values that are outside a given selection criterion, and replaced by valid values. Once the contact point values have been acquired, a probability algorithm processes the values. The probability algorithm determines the most probable gate position for the given contact point values. Also, between each dial position tested, a test to see whether the lock opens at the given combination is performed.

The wheel analysis begins a start terminator 302, moves to position wheels block 304 where the motor is directed to place the wheels of the lock in the proper position for the next sample using dial 1. Thereafter, dial 1 is rotated to place the lock cam in the detent position. The lock is now in the in the proper condition to gather the click or contact point data. The data acquisition card 26 is set up to take a data sample when triggered in block 308. Thereafter, computer 20 signals a motor move to motor system 30. When the indexer 32 starts to move motor 36 the data acquisition card 25 is triggered and the data sample is taken for a specific time period.

Typically, after the data sample is taken, the data sample is analyzed, the sample number at which the “click” or contact occurs is determined and stored in the appropriate file or data array. In the preferred embodiment multiple data samples are taken, thus the logic checks to see if the preselected number of samples have been taken in decision block 314. If all samples have not been taken the flow returns to block 308 to position the cam. When all samples have been taken at a given dial position the routine checks to see if all valid dial positions have been checked in decision block 316. For some embodiments of program 100 smaller or larger numbers of samples may be taken. If all valid dial positions for the wheel have not been checked, then the routine flow returns to position the wheels in block 304.

Probability Algorithm

When all valid dial positions for the wheel have been checked the routine flow moves to the probability algorithm 600. An exemplary algorithm is illustrated in detail in FIG. 5. The probability algorithm operates on the sets of acquired contact-point data, the data sets. Each set of data is an array of values, the length of which is equal to the number of dial positions sampled on a given wheel. Preferably, each dial position has multiple contact point values. Therefore, there are multiple sets of data, each set containing the number of dial positions sampled. For example, if five contact point values are obtained for each of one hundred dial positions on a given wheel, then we end up with five data sets, with each set containing one hundred values.

The probability algorithm 600 begins by obtaining the data set(s) in block 602. Thereafter the probability array is initialized in block 604 by setting the probability that a given dial position has a gate equal to one divided by the number of dial positions sampled. Next the algorithm retrieves a data set that has not been analyzed in block 606. In order to construct good models it is preferred that a smoothed version of the data set be calculated. The data set may be smoothed by doing a three point running average smooth on the data through fifty iterations in block 608.

Once a smoothed version of the data set is acquired, then the set of models may be constructed. Next, in block 610 a model for each dial position is generated, analyzed, and a gate probability determined for each dial position. In order to do effective probability analysis a set of models is needed to compare the data against. The number of models for a given data set will be equal to the number of dial positions sampled. The model itself is constructed as a n-value array, where n equals the number of dial positions sampled. Thus, the model can be viewed as another data set equal in length to the sets of contact point values. Each set of contact point values will have it's own set of models. Each of the models, in turn, are constructed from the smoothed version of the data set. There will be one model for each dial position.

In the ideal situation, the fence will drop into the gate at two dial positions. Thus, the model should reflect this by having two minimum values at the supposed gate. The value of the model's minimum is set to the smallest value of the contact point data set with the minimum values located at the dial position for which the particular model is generated. In this way a set of models is generated for each of the five sets of contact point values. Thus, for each data set, there are n models, where n equals the number of dial positions sampled. Additionally, each of the models in a given set of models corresponds to a gate prediction.

Once we have the sets of models, the probability analysis can commence. The probability analysis determines which of the models best describes the data. As each of the models corresponds to a gate prediction, the outcome of the probability analysis corresponds to the best prediction of the gate for the given sets of contact point values. This may be accomplished by comparing each of the models in the set of models with its respective set of contact point values, for each of the sets of contact point values. An exponential weighting scheme may be used to select the best or preferred model. That is, if a given model compares favorably with the data set, then the value of the probability of the gate prediction that the model represents is increased. The amount of increase is proportional to how well the model describes the data. This weighting scheme may then be used to update/alter the probability array. After completing the probability analysis for each dial position the probability array is normalized.

Next the algorithm flow moves to decision block 612. If each dial position in a given data set has not been evaluated, then the program flow returns to block 610 described above. When all dial positions for the data set have been evaluated the logic flow continues to decision block 614. If one or more data sets remain to be evaluated the algorithm flow returns to block 606 where the next data set is obtained. When all data sets have been processed the dial position with the largest probability is returned in terminator 616. In some embodiments more than one dial position together with the probability of that dial position may be returned when the logic flow returns to the wheel analysis routine 300.

After returning to the wheel analysis routine the logic flow moves to terminator 318, which returns the value(s) provided by terminator 616 to the main line program 100. Thereafter, the flow moves to decision block 108 that checks to see if the lock opened during the wheel analysis routine since the wheel analysis routine typically tests for the lock to open at each dial position tested. If the lock opened, then the logic flow moves to done terminator 500.

When the lock is not open, the logic flow continues to wheel analysis 300 for wheel two. After the lock opened or the wheel analysis for wheel two was complete the program flow moves to decision block 110. Similar to decision block 106, decision block 110 checks to see if the lock opened. If the lock opened, then the logic flow moves to done terminator 500.

When the lock is not open, the logic flow continues to auto-dial wheel one in auto-dial routine 400. Wheel one is auto-dialed using wheel three and wheel two gate positions as determined from the wheel three and wheel two analyses respectively. Wheel one is checked for each valid dial position. Preferably, utilizing single dial position increments. In some embodiments, the increment can be increased up to two dial positions. After the lock opened or the auto-dial routine was complete the program flow moves to decision block 112. Similar to decision block 106, decision block 112 checks to see if the lock opened. If the lock opened, then the logic flow moves to done terminator 500.

When the lock is not open, the logic flow re-performs the low points analysis using the fine mode of low point analysis described above. The program flow then repeats the test for open in decision block 114 followed by the wheel three analysis. When the lock is not open, the logic flow continues to wheel analysis 300 for wheel two after checking for open in decision block 116. After the lock opened or the wheel analysis for wheel two was complete the program flow moves to decision block 118. Similar to decision block 106, decision block 118 checks to see if the lock opened. If the lock opened, then the logic flow moves to done terminator 500.

When the lock is not open, the logic flow continues to auto-dial wheel one in auto-dial routine 400. Wheel one is auto-dialed using wheel three and wheel two gate positions as determined from the wheel three and wheel two analyses respectively. Wheel one is checked for each valid dial position. Preferably, utilizing single dial position increments. In some embodiments, the increment can be increased up to two dial positions. After the lock opened or the auto-dial routine was complete the program flow moves to decision block 120. If the lock opened, then the logic flow moves to done terminator 500.

When the lock is not open, the logic flow moves to perform the wheel analysis on wheel one using the gate positions determined for the other two wheels form their wheel analyses. The lock is checked for open in decision block 122. If the lock opened, then the logic flow moves to done terminator 500.

When the lock is not open, the logic flow re-performs the wheel three analysis. When the lock is not open, the logic flow continues to wheel analysis 300 for wheel two after checking for open in decision block 124. After the lock opened or the wheel analysis for wheel two was complete the program flow moves to decision block 126. Similar to decision block 106, decision block 126 checks to see if the lock opened. If the lock opened, then the logic flow moves to done terminator 500.

When the lock is not open, the logic flow continues to auto-dial wheel one in auto-dial routine 400. Wheel one is auto-dialed using wheel three and wheel two gate positions as determined from the wheel three and wheel two analyses respectively. Wheel one is checked for each valid dial position. Preferably, utilizing single dial position increments. In some embodiments, the increment can be increased up to two dial positions. After the lock opened or the auto-dial routine was complete the program flow moves to decision block 128. If the lock opened, then the logic flow moves to done terminator 500. When the lock is not open, the logic flow moves to end terminator 130 where the program ends without opening the lock. Group II Approach

The program logic currently employed in the Group II program 1000 is illustrated in FIGS. 6 through 12. the logic shown for program 1000 begins at start 1002 with program initiation. The program 1000 is activated through an icon placed either in the start menu or as a shortcut on the desktop of the computer. Alternatively, the program 1000 may be started by employing any other method selected by the user or programmer. Some embodiments of program 1000 may be password protected to prevent unauthorized use of the program 1000. Consequently, the user may be prompted to enter a password during the initiation of program 1000.

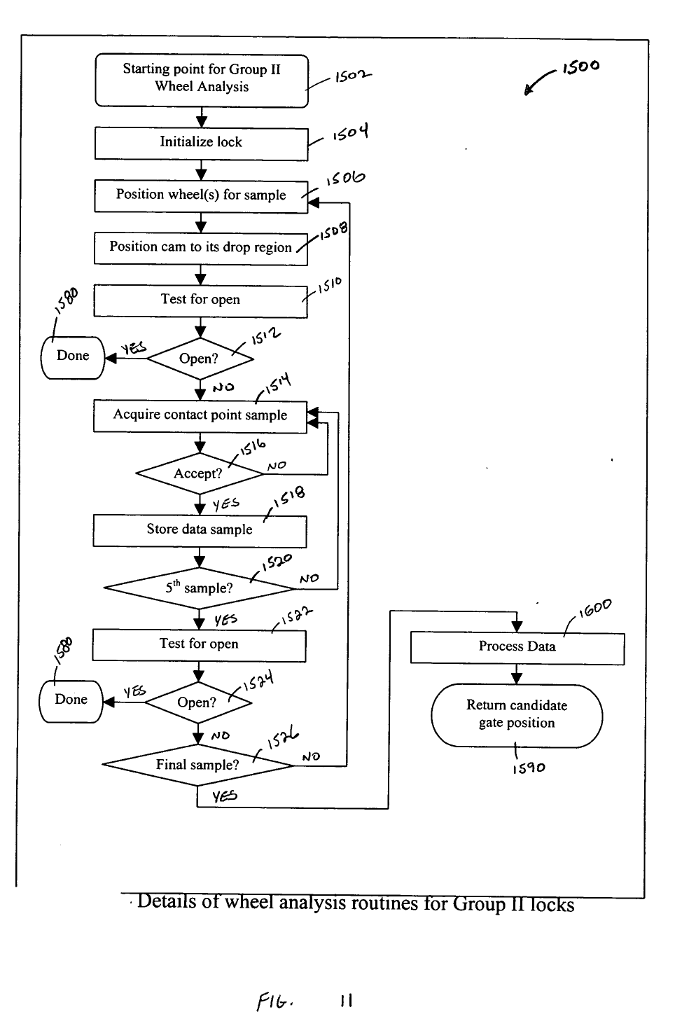

Thereafter, the program flow may move to block 1004 where the user could select the lock and method to be utilized. Block 1004 may display a screen 1800 similar to that shown in FIG. 13. Screen 1800 is designed for user input and enables the user to select the lock type and the method in which the lock is to be manipulated if applicable. Currently there are three lock types covered: S&G 6730, LaGard 3330, and IIco 673. There are currently two methods for each lock type that the user can select. The methods involve mainly how the program will select the wheel order and/or what type of model to use.

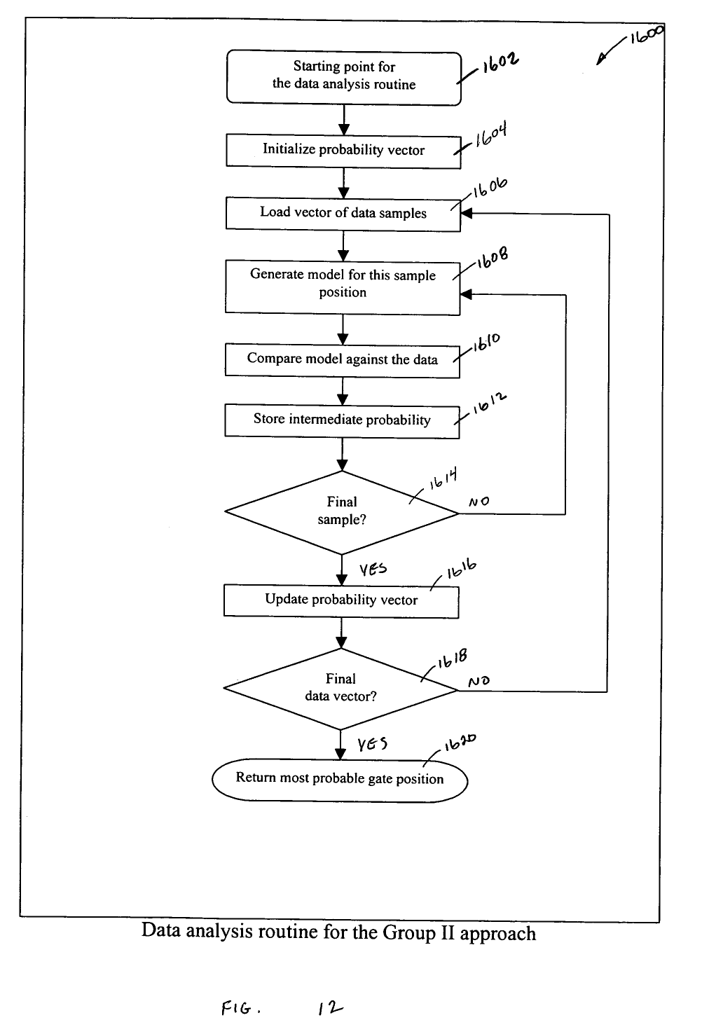

The user may also select the approach the program will take in setting up the gain and cam start position. Two options are currently available. The first option is labeled “Automatic.” In this case the program searches for the contact point and if found sets the gain level for the transducer. If an acceptable gain level is found, the program proceeds to manipulate the lock. If “Automatic with Review” is selected, the program will still attempt to find the contact point as well as set an acceptable gain level. But before continuing to manipulate the lock, a review window 1805 is displayed. An example is shown in FIG. 14. Two windows are displayed, the data window 1810, which is a graphical representation of the “click” data, and an options dialog window 1820. The options are self-explanatory, and allow the user to adjust the gain settings and the cam park position, which is the cam start position, in order to optimize the settings. This may be necessary in cases where the lock is mounted to a container that makes it difficult to pick up a strong signal, or in cases where the lock is mounted in a noisy environment. In such cases, the user may be able to better set the gain and cam park position.

In the event that “Automatic” was chosen, and either the contact point can not be found or an acceptable gain setting can not be found, the review window 1805 is automatically displayed and the user may manually set the gain and cam start position in order to proceed to the manipulation routines.

Decision blocks 1006, 1008, 1010, and 1012 represent the selection of the appropriate software routine to call based on the user's input on screen 1800.

Next, manipulation of the selected lock begins utilizing the subroutine represented by blocks 1100, 1200, 1300, and 1400. Depending on the lock type and the method chosen, the program will iterate through the wheels and attempt to find the wheel gates and open the lock.

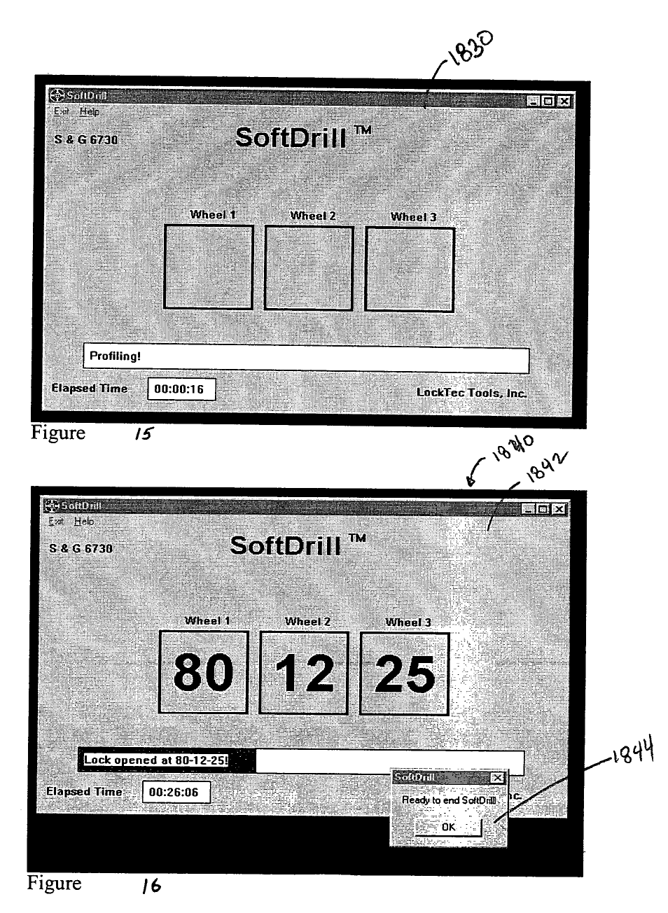

Currently the S&G 6730 has two methods. The two methods involve a trade-off between time to open and robustness of the approach. The trade off in time is gained by forcing the wheel order in which the wheels are tested, or “profiled,” rather than going through additional steps in order to determine the order in which the wheels are tested. Method 1 shown in block 1100 attempts to open the lock by forcing the wheel order. The order is detailed later in this document. Method 2 represented by block 1200 goes through additional steps to select which wheel should be tested. It is generally believed that roughly 70% of S&G 6730 locks will open using the wheel order given by Method 1. After completing Method 1 in block 1100 the program 1000 checks for a lock open in decision block 1028. If the lock was open, program 1000 may display the end screen 1840 shown in FIG. 16. When the lock was not opened, program 1000 may call Method 2 with block 1200.

Similarly, after processing S & G Method 2 in block 1200, program 1000 checks for a lock open in decision 1032. Thereafter, the program flow moves to done terminator 1080 discussed above or may end at terminator 1090.

When S & G Method 2 was called first in block 1200, decision block 1030 checks for open with similar results as decision block 1028 discussed above. The difference being that if the lock did not open S & G Method 1 would be called in block 1100. Thereafter, the lock condition is again checked in decision block 1034 with results similar to those discussed in decision block 1032.

The process for the IIco 673 lock is similar to that employed with the S & G 6730 lock. Depending on the user selection at screen 1800 the program flow moves to either IIco 673 Method 1 in block 1300 or IIco 673 Method 2 in block 1400. Thereafter, the program 1000 checks for a lock open in either decision block 1044 or 1046 with similar results to those discussed above for decision block 1032. If the lock remains locked, then the method not attempted may be utilized. Thereafter, the program 1000 checks for a lock open in either decision block 1048 or 1050 with similar results to those discussed above for decision block 1032. Currently, no specific correlation between a group of ILCO locks and a particular method has been found.

The methods for the LaGard 3330 are related to the vintage of the lock. Method 1 shown in block 1024 is used for locks that are from early to mid 1980's. Method 2 illustrated in block 1026 is used for locks that are newer than mid 1980's. The reason for two methods stems from differences in the wheel shapes for these two eras.

After processing either LaGard Method 1 in block 1200 or Method 2 in block 1200, program flow may check for lock open at decision block 1036 and 1040 respectively. If the lock opened then the illustrated program flow moves to done terminator 1080 discussed above. When the lock was not open the program flow moves to perform the method not already performed. Thereafter, the program flow may check for open at decision block 1038 and 1042 respectively. If the combination was found and the lock opened the flow moves to done terminator 1080 as discussed above. When the lock was not open the program may end at terminator 1090.

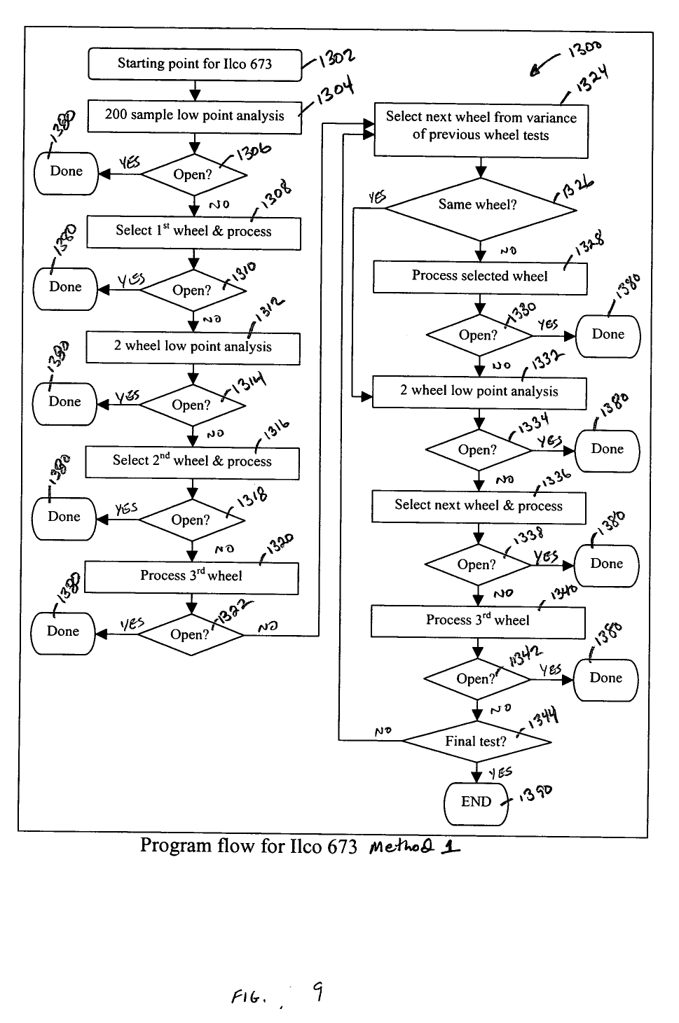

To trigger the above program flow the user selectable inputs obtained and the user clicks on the “START” button 1802 if in the setup window 1800 or selects the “Continue test” check box 1822 in the review window dialog box 1820. The next window to appear may be the wheel processing window 1830, an example of which is shown in FIG. 11. In the upper left corner of this window, the selected lock type is displayed. In the center of the screen are three boxes. The three boxes display the candidate gate values for the wheels as they are determined. A single-line message box is included below the wheel boxes that are used to display a message that describes the current process. This box is also updated with a blue progress indicator, which shows how far into the displayed process the program is. Finally, below the message box is the elapsed time box. This box displays how much time has elapsed since the program was started.

When the program has either opened the lock or has come to its end in the event the lock was not opened, a message box is displayed to indicate to the user that the program is ready to end. An example message screen 1840 is shown in FIG. 16.

Program flow for S&G 6730 Method 1

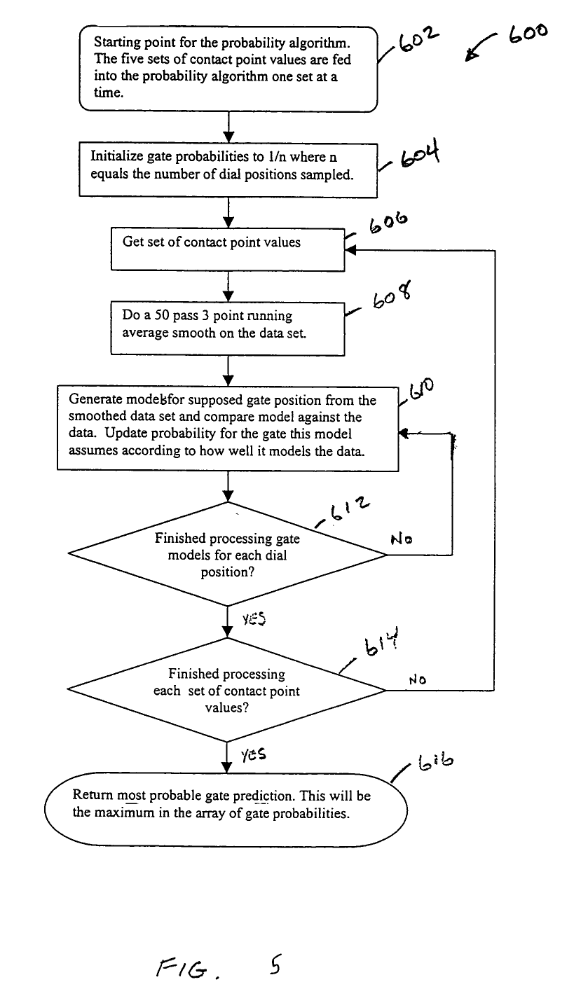

When the S & G 6730 Method subroutine 1100 is called from manipulator program 1000, the subroutine illustrated in FIG. 7 begins at start terminator 1102. At this point the user has selected S&G 6730 and method 1, and has initiated the start of the profiling process, or the program 1000 failed to open the lock using Method 2 subroutine 1200.

After initializing the subroutine 1100 in start terminator 1102 a coarse low point analysis is performed in block 1104. The illustrated subroutine selects 80 points/combinations to test. This analysis is done to select a set of park positions for the wheels that correspond to a low height of the fence on the wheel(s). This is accomplished by running 80 combinations, where the park positions of each of the wheels are spread across the circumference of each wheel. The combination that gives the lowest contact point value is returned. The subroutine 1100 does a test for open at each of the combinations in case one of the combinations is in fact the true combination.

This check for open is represented by decision block 1106. If the lock opened the subroutine would return to the program 1000 with the opening combination at terminator 1180. If the lock was closed the subroutine flow moves to process wheel 3 in block 1108.

For the S&G 6730 method 1, the process uses a forced wheel order. The first wheel to be processed is the outermost wheel, designated as wheel three. The reason wheel three is selected as the first wheel to process is because it is generally believed that in roughly 70% of the S&G 6730 locks, the fence favors wheel three. So wheel three is processed first, with wheel two, the middle wheel, and wheel one, the innermost wheel, at the positions determined from the low point analysis.

A test for open represented by decision block 1110 is included before data is sampled, as well as after, for each set of wheel positions. This ensures that a lock open is detected when the fence is on the edge of one or more of the gates and drops in as a result of sampling at that location. In this way, the program will handle cases where the lock has opened because the fence dropped while the data samples were being collected. If this condition were not handled, there could be a risk that the motor could bind up while trying to process a motor move command, due to the fact that the lock had opened and the bolt was retracted preventing further movement of the lock dial. If a lock open is detected in decision 1110, the program alerts the user with a message window 1840, and program 1000 execution is halted utilizing terminator 1180 as discussed above.

If the lock did not open, subroutine 1100 flow continues to process wheel two in block 1112. At this point the program has a candidate gate position for wheel three, the first wheel tested. With wheel three at its candidate gate position and wheel one at its low point position, wheel two, the middle wheel, is processed in similar fashion as wheel three above. The test for open for wheel two is represented by decision 1114 with similar results as decision 1110 above. If the lock has not opened, then subroutine 1100 auto-dials wheel one in block 1116.

At this point the program has candidate gate positions for wheel three and wheel two. With wheel three and wheel two at their respective candidate gate positions, wheel one is parked at each of its dial positions and a test for open is done at each of the positions. If the candidate gates for wheel three and wheel two are correct, the lock will open when wheel one is positioned at its gate position and a test for open is done. This test is represented by decision 1118. If the lock does open, the combination is posted in the message box 1840, the wheel boxes will also display the combination, a message window is displayed to alert the user that the combination has been found, and the program halted.

If the lock remains closed then the subroutine 1100 may check to see how many times the above described process has been performed or if a fine low points analysis has been performed in decision 1120. If this is the first time through or a fine low points has not been completed the subroutine continues to block 1122 where a fine low points analysis is performed. If the lock did not open up to this point, a more detailed low points analysis is done, and the above wheel tests are repeated. For example, by running 200 combinations, a finer resolution on the wheels is achieved, and typically a lower contact point value is achieved. By starting the next iteration of wheel tests with a lower contact point value, the chances of getting the true gate positions on the following tests are improved. One drawback to running more combinations is the added time it takes to do so. Again, a test for open represented by decision 1124 is done at each combination to cover the chance that one of the combinations is in fact the true combination.

Thereafter, the program flow returns to block 1108 to report the wheel analysis as discussed above. After returning to decision 1120 a second time the subroutine 1100 flow moves to block 1126 to process wheel one.

If the two passes through the wheel three, wheel two, and wheel one tests have failed to open the lock, there is a distinct possibility that the fence does not favor wheel three, but favors wheel two or wheel one. As the order of the wheel tests are forced, the next wheel to be tested is wheel one. This is done with wheel three and wheel two at their respective candidate gate positions as determined by there most recent test results. Similar to processing wheel three or wheel two the subroutine checks for lock open. This check is represented by decision 1128. If the lock is not open the subroutine 1100 continues to block 1130 to test wheel two a third time.

At this point, wheel two is processed with wheel three and wheel one at their respective candidate gate positions as determined by their most recent wheel tests. While processing wheel two the subroutine checks for open as discussed above for block 1112. The check is represented by decision 1132. Thereafter, if the lock is still closed wheel three is auto-dialed in block 1134. This is the last process in the program flow for S&G 6730 method 1. With candidate gate positions for wheel one and wheel two, wheel three is auto-dialed through its dial positions. A check for open is performed at each dial position. This check is represented by decision 1136. Thereafter, the program 1000 ends by displaying the appropriate dialogue window called by terminator 1190 or 1180.

Program flow for S&G 6730 Method 1. LaGard 3330 Method 1 & Method 2

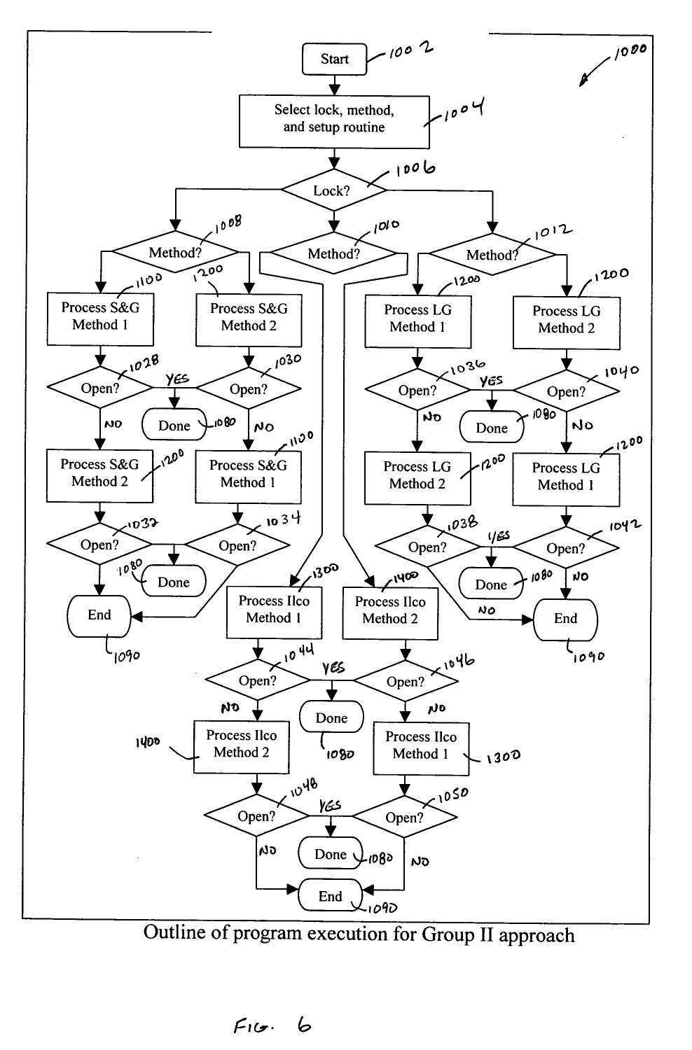

FIG. 8 illustrates an exemplary subroutine 1200 that may be utilized in S & G 6730 Method 2, LaGard 3330 Methods 1 and 2. The differences between LaGard Method 1 and 2 are found in the subroutines called. The program logic shown begins at start terminator 1202 where subroutine 1200 is called and initial conditions established. Thereafter, the subroutine 1200 performs a coarse low point analysis in block 1204.

This analysis is done to find a set of park positions for the wheels that corresponds to a low contact point value, and thus a low fence height on the wheel(s). This may be accomplished by running 125 combinations, where the park positions of each of the wheels are spread across the circumference of each wheel. The combination that gives the lowest contact point value is returned. The program does a test for open represented by decision 1206 at each of the combinations in case one of the combinations is in fact the true combination. If the lock opens, then the subroutine returns with the valve of the opening combination in done terminator 1280 similar to terminator 1180 discussed above.

When the lock did not open, then the program flow moves to select the first wheel to process in block 1208. The first wheel is determined by doing a variance analysis on the data from each wheel as gathered by the low point analysis. The wheel whose data gives the largest variance is indicative of the wheel that the fence is in contact with the most. As such, this wheel is selected as the first wheel to process. This is only one approach that can be taken in order to try to determine which wheel the fence favors. Once the order of the wheels has been determined, the selected first wheel is profiled.

Profiling the first wheel involves positioning the two wheels not selected at their low positions as determined from the low point analysis. The selected wheel may be positioned at every dial position and contact point data is gathered at each location. It was decided to do every dial position for the sake of improving the candidate gate selection. Testing every 1.5 dial positions or every other dial position are alternative approaches.

A test for open represented by decision 1210 is included before data is sampled, as well as after, for each sample position. This ensures that a lock open is detected when the fence is on the edge of one or more of the gates and drops in as a result of sampling at the given location. In this way, the program may handle the case where the lock has opened because the fence dropped while the sample data was being collected. If this condition were not handled, there could be a risk that the motor could bind up while trying to process a motor move command, due to the fact that the lock had opened and the bolt was retracted preventing further movement of the lock dial. If a lock open is detected, the program alerts the user with a message window, and program execution is halted in done terminator 1280.

When the lock remains closed a two-wheel low point analysis is performed in block 1212. At this point the program has a candidate gate position for the first wheel tested. This wheel is positioned to its candidate gate position and contact point data is taken with the other two wheels positioned at pairs of locations. The idea is to get a park position for the untested wheels having a lower contact point than previously obtained from the low point analysis of block 1204. The lowest of the wheel positions is returned. Again, the program checks whether the lock has opened at each of the wheel locations for a given data sample. This check is represented by decision 1214.

When the lock remains closed the second wheel to analyze is selected and processed in block 1216. The wheel to process next is determined by running a variance analysis on the data from the two wheel low point analysis. The wheel having the larger variance is selected as the next wheel to process. The selected wheel is processed with the untested wheel at the position determined from the two wheel low point analysis 1212, and the first wheel tested at its candidate gate position. The program checks for lock opens throughout the wheel test. This check for open is represented by decision 1218.

When the lock remains closed the third wheel is processed in block 1220. The first two wheels have been processed at this point. Contact point data is acquired for the third wheel with the first two wheels at their respective candidate gate positions. If the lock opens, as represented by decision 1222, while the current wheel is tested, the program alerts the user and halts at terminator 1280.

If the lock remains closed, the subroutine flow may continue to perform a high wheel analysis at block 1224. At this point, one iteration through the wheel test has occurred, so the program has candidate gates for each wheel. The high wheel analysis is another approach in attempting to determine which wheel the fence is in contact with most. This is done by taking a number of contact point samples across the wheels with the other wheels at their candidate gate positions. A variance analysis for each wheel is then used to select the next wheel to process. The wheel whose data gives the largest variance is selected. This is just another variation on the theme, and as such is only one of any number of approaches that could be employed to determine which wheel the fence favors most. As with the low point analysis 1204 the check for open represented by decision 1226, is performed at each sample point.

When the lock remains closed the next wheel to process is selected in block 1228. As mentioned in the previous section, the results from the high wheel analysis are used to determine which wheel is selected for processing. The selected wheel is processed with the other two wheels at their candidate gate positions. As with the other wheel processing discussed above a check for open, represented by decision 1230 is performed at each test point.

With the lock remaining closed, the subroutine flow continues to block 1232 where a two wheel high wheel analysis is conducted. This routine parks the previously tested wheel at its candidate gate position, and then tests each of the two remaining wheels at a number of park positions. While data is gathered for one of the two “untested” wheels, the other is parked at its candidate gate value as determined in the previous iteration of tests. A variance analysis of the data gathered for the two wheels next in line to be processed is used to determine which wheel is selected. The wheel whose data gives a larger variance is selected as the next wheel to process. As discussed above, for the high wheel analysis, a test for open, represented by decision 1234 is conducted at each test point.

If the lock remains closed the next wheel to process is selected and tested in block 1235. The selected wheel is processed with the other two wheels parked at their respective candidate gate positions as determined from their most recent wheel test. Similar to the other wheel tests discussed above a check for open represented by decision 1236, is performed.

Thereafter, if the lock has not opened the untested wheel is processed in block 1238. The untested wheel is the wheel that has yet to be processed for the current iteration of wheel tests. This is done with the other two wheels at their respective candidate gate positions as determined from their most recent wheel test. If the lock opens in decision 1240, the combination is displayed and a message window alerts the user that the program has ended at terminator 1280. If the lock does not open, a message is displayed that informs the user the lock did not open, and the program is halted at terminator 1290.

Program flow for IIco 673 Method 1

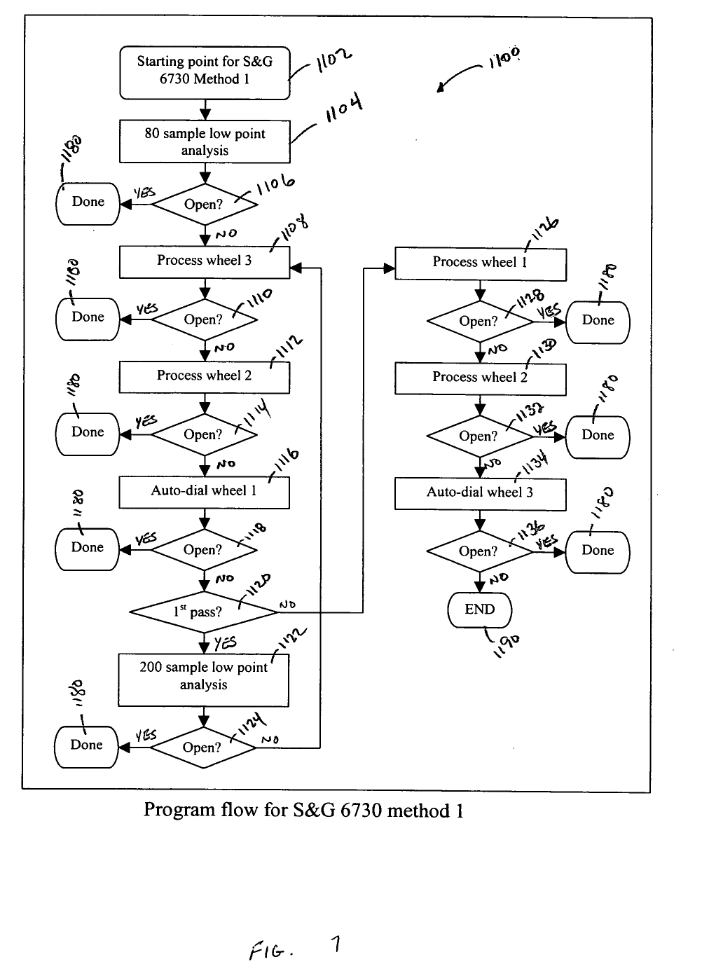

FIG. 9 illustrates an exemplary subroutine 1300 that may be utilized to open the IIco 673 lock. The subroutine shown begins at 1302. At this point the user has selected the IIco 673 lock Method 1, and has initiated the start of the profiling process.

After initializing subroutine 1300 at start 1302 the program flow moves to block 1304 where a fine low point analysis is performed. A fine low point analysis is performed instead of a course analysis due to the close tolerance between wheels. This analysis is done to select a set of park positions for the wheels that corresponds to a low contact point value, which means the height of the fence on the wheel(s) is relatively low. This may be accomplished by running 200 combinations, where the park positions of each of the wheels are spread across the circumference of each wheel. The combination that gives the lowest contact point value is returned. The program does a test for open represented by decision 1306, at each of the combinations in order to cover the case that one of the combinations is in fact the true combination.

With the lock in the closed position, the subroutine 1300 flow continues to select and process the first wheel. The order of the wheels is determined by a variance analysis on the data from the fine low point analysis for each wheel. The wheel whose data variance is the largest is indicative of the wheel that the fence is in contact the most. This is only one approach that can be taken in order to try to determine which wheel the fence favors. Once the wheel has been determined, the selected wheel is profiled.

Profiling the selected wheel involves positioning the other two wheels at their low positions as determined from the fine low point analysis. The selected wheel is positioned at locations about its circumference and data is sampled at each location. Currently the program takes data at every dial position. It was decided to do every dial position in order to have the best chance of obtaining the candidate gate from the data analysis routine. Testing every 1.5 dial positions or every other dial position are alternative approaches.

A test for open represented by decision 1310 is included before data is sampled, as well as after, for each sample position. This ensures that a lock open is detected when the fence is on the edge of one or more of the gates and happens to drop in as a result of the sampling process. If this condition were not handled, there could be a risk that the motor could bind up while trying to process a motor move command, due to the fact that the lock had opened and the bolt was retracted preventing further movement of the lock dial. If a lock open is detected in decision 1310, the program alerts the user with a message window, for example, screen 1840, and the program is halted at terminator 1380.

When the lock remains closed, the subroutine 1300 flow moves to block 1312 to perform a two-wheel low point analysis. At this point the program has a candidate gate position for the first wheel tested. This wheel is positioned at its candidate gate position and the other two wheels are positioned at pairs of locations in order to try to get a contact point that is lower than the previous low contact point value obtained from the fine low point analysis. The lowest of the two wheel positions is returned. Again, the program checks whether the lock has opened, represented by decision 1314, at each of the wheel locations tested.

If the lock remains closed, the program flow moves to select the next wheel to process in block 1316. The wheel to process next is determined by running a variance analysis on the data from the two-wheel low point analysis. The wheel having the larger variance is selected as the next wheel to process. The selected wheel is processed with the untested wheel at the position returned by the two wheel low point analysis, and the first wheel tested at its candidate gate position. The program checks for lock opens, represented by decision 1318 throughout the wheel test.

With the lock still closed the subroutine 1300 flow moves to block 1320 to process the third wheel. Two wheels have been processed at this point. The third wheel is now processed with the previously tested wheels at their respective candidate gate positions. Again the program checks for lock opens, represented by decision 1322, at each sample position.

When the lock remains closed the subroutine 1300 continues to block 1324 to determine the next wheel to be tested. Whereas in the previous approach the variance of low point analysis was used to determine which wheel should be tested next, this routine uses the data from the previous wheel tests themselves in order to determine which wheel should be tested next. It is the variance of the contact point data from the previous wheel tests that is used to select the next wheel to test. As before, the larger variance determines which wheel is selected.

Decision 1326 is included in order to prevent a repeat test of the most recently tested wheel. If the selected wheel is the wheel that has just been tested, the program skips over the test for this wheel and moves on to perform the two wheel low point analysis in block 1332 using the results from the previous tests.

When the selected wheel is different than the last wheel tested the program flow moves to block 1328 to process the selected wheel. The selected wheel is processed with the other two wheels at their respective candidate gate positions based on their most recent wheel test. The lock is tested at each sample position to see whether or not the lock has opened. This test is represented by decision 1330.

With the container still closed, the subroutine 1300 flow continues to perform a two-wheel low point analysis in block 1332. This routine is done to gather variance data for the two wheels remaining in this iteration of wheel tests. The previously tested wheel is parked at its candidate gate position for the data acquisitions in this routine. One of the two remaining wheels is parked at its candidate gate position as determined from its previous wheel test while the other wheel is positioned in locations spread across its circumference. Then the roles of the remaining two wheels are reversed and data is gathered for the other wheel. The wheel whose data gives a larger variance value is the wheel that is selected to be tested next. Additionally, a test for open is performed at each date location. This test is represented by decision 1334.

Thereafter, if the lock is still closed, the logic flow continues to block 1336 where the next wheel is selected and processed. At this point the first of the two remaining wheels in this iteration of wheel tests is selected and tested. The other two wheels are positioned at the candidate gate positions, respectively, of their most recent wheel test. The lock is tested for lock open, as represented by decision 1338, at each sample position.

With the lock remaining locked the remaining wheel of this iteration of wheel tests is processed in block 1340 with the other two wheels at the candidate gate positions obtained from their most recent wheel tests. The lock is tested for lock opening at each sample position. This test is represented by decision 1342.

If the lock has not opened decision 1344 determines if the predetermined number of iterations has passed. Each iteration consists of a set of the three wheel tests, except for the case where the first wheel in the iteration was skipped because it would cause a repeat of the same wheel test. The current program does a total of four iterations. If the lock has not opened in four iterations, the program alerts the user with a message window and program execution is halted at terminator 1390.

Program flow for IIco 673 Method 2

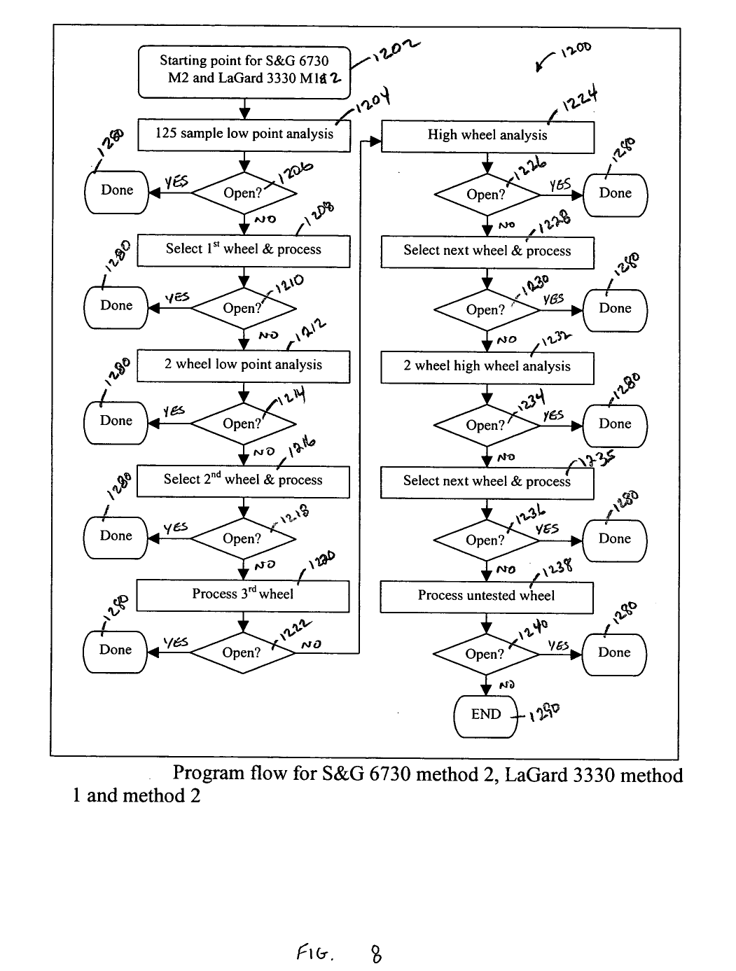

FIG. 10 illustrates an exemplary subroutine 1400 that may be utilized to open an IIco 973 lock. This subroutine provides an alternative to the logic described for ILCO 673 Method 1. The subroutine 1400 shown begins at start 1402. At this point the user or program 1000 has selected the IIco 673 lock Method 2, and has initiated the start of the profiling process.

After initializing subroutine 1400 at start 1402 the program flow continues to block 1404 where a coarse low point analysis is performed. A course analysis is performed as an alternative to provide different starting conditions. Alternatively, a fine low point analysis that utilized a different set of data points could also be utilized. This analysis is done to select a set of park positions for the wheels that correspond to a low contact point value, which means the height of the fence on the wheel(s) is relatively low. This may be accomplished by running 125 combinations, where the park positions of each of the wheels are spread across the circumference of each wheel. The combination that gives the lowest contact point value is returned. The program does a test for open represented by decision 1406 at each of the combinations in order to cover the case that one of the combinations is in fact the true combination.

Thereafter, if the lock has not opened, the subroutine continues to block 1408 to select and process the first wheel. The order of the wheels is determined by a variance analysis on the data from the low point analysis for each wheel. The wheel whose data variance is the largest indicates the wheel that the fence is in contact the most. This is only one approach that can be taken in order to try to determine which wheel the fence favors. Once a wheel is selected, the wheel is profiled.

Profiling the selected wheel involves positioning the other two wheels at their low positions as determined from the low point analysis. The selected wheel is positioned at locations about its circumference and data is sampled at each location. Currently, the program takes data at every dial position. It was decided to do every dial position in order to have the best chance of obtaining the candidate gate from the data analysis routine. Testing every 1.5 dial positions or every other dial position are alternative approaches.

A test for open, represented by decision 1401, is included before data is sampled, as well as after, for each sample position. This ensures that a lock open is detected when the fence is on the edge of one or more of the gates and happens to drop in as a result of the sampling process. If this condition were not handled, there could be a risk that the motor could bind up while trying to process a motor move command, due to the fact that the lock had opened and the bolt was retracted preventing further movement of the lock dial. If a lock open is detected in decision 1410, the program alerts the user with a message window, for example, screen 1840, and the program is halted at done terminator 1480.

When the lock remains closed or locked, subroutine 1400 continues to perform a two-wheel low point analysis at block 1412. At this point the program has a candidate gate position for the first wheel tested. This wheel is positioned at its candidate gate position and the other wheels are positioned at pairs of locations in order to try to get a contact point that is lower than the previous low contact point value obtained from the low point analysis of block 1404. The park position of the sample corresponding to the lowest pair is returned. Again, the program checks whether the lock has opened, represented by decision 1414, at each of the wheel locations for a given data sample.

If the lock has not opened, program flow moves to select and process the next wheel in block 1416. The wheel to process next is determined by running a variance analysis on the data from the low point analysis 1404. The wheel having the larger variance is selected as the next wheel to process. The selected wheel is processed with the untested wheel at the position returned by the low point analysis 1404, and the first wheel tested at its candidate gate position. The program checks for lock opens, as represented by decision 1418, throughout the wheel test.

Thereafter, when the lock fails to open, the third wheel is processed. The first two wheels have been processed at this point. The third wheel is now processed with the previously tested wheels at their respective candidate gate positions. Again the program checks for lock opens, represented by decision 1422, at each sample position.

If the lock remains closed, the next wheel is selected from variance of previous wheel tests in block 1424. This routine is done to determine the next wheel to be tested. Whereas in other approaches the variance of low point analyses was used to determine which wheel should be tested next, this routine uses the data from the previous wheel tests themselves in order to determine which wheel should be tested next. It is the variance of the contact point data from the previous wheel tests that is used to select the next wheel to test. As before, the larger variance determines which wheel is selected.

Decision 1426 is included in order to prevent a repeat test of the most recently tested wheel. If the selected wheel is the wheel that has just been tested, the program skips over the test for this wheel and moves on to select and process the next wheel 1432 variance of the contact point data as discussed above for block 1424.

If the wheel selected is different then the last wheel processed, then the wheel is processed in block 1428. The selected wheel is processed with the other two wheels at their respective candidate gate positions based on their most recent wheel test. The lock is also tested at each sample position to see whether or not the lock has opened. This test is represented by decision 1430.

When the lock remains closed/locked the subroutine may select and process the next wheel in block 1432. At this point the first of the two remaining wheels in this iteration of wheel tests is selected and tested. This is the second wheel selected to test as based on the variance from the previous wheel tests. The other two wheels are positioned at the candidate gate positions, respectively, of their most recent wheel test. The lock is tested for lock opens at each sample position. This test may be represented by decision 1434.

Thereafter, if the lock has not opened, the remaining wheel of this iteration of wheel tests is processed with the other two wheels at the candidate gate positions obtained from their most recent wheel tests. The lock is tested for lock open at each sample position. This test is represented by decision 1438.

When the lock remains closed, if may be desirable to repeat all or a portion of subroutine 1400. The subroutine 1400 illustrated in FIG. 10 repeats the portion of the subroutine beginning at block 1424 a predetermined number of times. Decision 1440 determines if the requested number of iterations has passed. Each iteration consists of a set of the three wheel tests, except for the case where the first wheel in the iteration was skipped because it would cause a repeat of the same wheel test. The current program does a total of four iterations. If the lock has not opened after four iterations, the program alerts the user with a message window and program execution is halted at terminator 1490.

Details of Wheel Analysis Routines for Group II Locks

FIG. 11 provides an example of the logic that may be utilized to process a particular wheel. Subroutine 1500 is typically called each time a wheel is processed in FIGS. 7-10 discussed above. Prior to processing any of the wheels, the park positions of the wheels not tested are typically determined.

After initializing subroutine 1500 at start 1502 the lock may be initialized in block 1504. Initializing the lock may be accomplished by rotating the dial four complete revolutions in the counterclockwise direction, picking up all wheels, and positioning the dial to zero. This gives the program a point of reference for subsequent dial moves.

The wheel under test is then positioned to its sample position, and the other wheels are positioned to their park positions in block 1506. Thereafter, the cam is positioned to the cam start position as determined from the setup routine. This is typically about four dial positions from the contact point in block 1508.

A test is done in block 1510 and decision 1512 to see whether the current wheel positions are in fact the combination of the lock. If this test were not done, the next dial movement could cause the motor to bind, after opening the lock, potentially causing unpredictable behavior of the program. More than likely, the program could issue an error such as a motor slip error, as slippage of the belt may be tracked throughout the program, and the program would end. If the lock opens the opening combination is returned and the program 1000 ends. An example of a screen that may be displayed after the combination has been found is shown in FIG. 16.

When the lock remains locked, the subroutine 1500 flow continues to block 1514 to acquire contact point data. This is where the actual data sample is obtained. The data acquisition card arms a trigger for data acquisition. A motor move command triggers the data acquisition, and the input buffer is filled with the signal obtained from the transducer. The acquired signal is processed to determine where the contact point occurred in the buffer, and the index of the buffer where the contact point occurred is returned as the contact point value. In order to determine where the contact point value occurred, the current program has a predetermined threshold value. The place where the data exceeds the threshold is considered to be the location of the contact point. A check is performed to determine whether this contact point value is accepted or not in decision 1516. This is where the contact point value is accepted or rejected. The current program determines an initial reference contact point value from the setup routine. This reference value may be updated with a value from the last low point analysis. A window may be placed about the reference contact point value, and subsequent contact point values that fall outside this window are rejected as extraneous noise. Exemplary windows include samples, time, and/or distance moved. Currently, a window of +/−300 samples or +/−15 msec is utilized. If the data sample is rejected the subroutine returns to block 1514 to take another sample.

When the data sample was accepted, the data is stored in block 1518. The current program stores the first five valid contact point values. The reason for this is that the five values can vary somewhat and spurious contact point values tend to be averaged out in the data analysis routine 1600 discussed below.

If the predetermined number of samples have not been acquired, then the subroutine 1500 returns to block 1514 to acquire additional data.

After obtaining the required data samples, the lock is tested to see whether the current wheel positions are the combination positions using block 1522 and decision 1524.

When the lock remains locked, subroutine 1500 checks to see if all data samples for the given wheel have been acquired in decision 1526. If additional samples are required the subroutine 1500 returns to block 1506 to position the wheel for the next sample

When the data sampling for a wheel is complete the acquired data is processed in process data subroutine 1600. This is the data analysis routine. The contact point values for each data sample result in data vectors that are fed to the data analysis routine from which the candidate gate is determined.

The wheel analysis 1500 returns the candidate gate position to the calling program with terminator 1590.

Data Analysis Routine for the Group II Approach

In the data analysis routine 1600 a data vector is compared against models, from which an intermediate probability vector is computed, and the intermediate probability vector is used to update the overall probability vector. The differences between locks and/or methods involve how the data is conditioned prior to the probability analysis, the size of the data matrix, and the models used in the analysis. For the Group II approach, the data is not conditioned but the contact point values are used directly. Also, for the Group II approach, the data matrix consists of rows, one row for each of the samples.

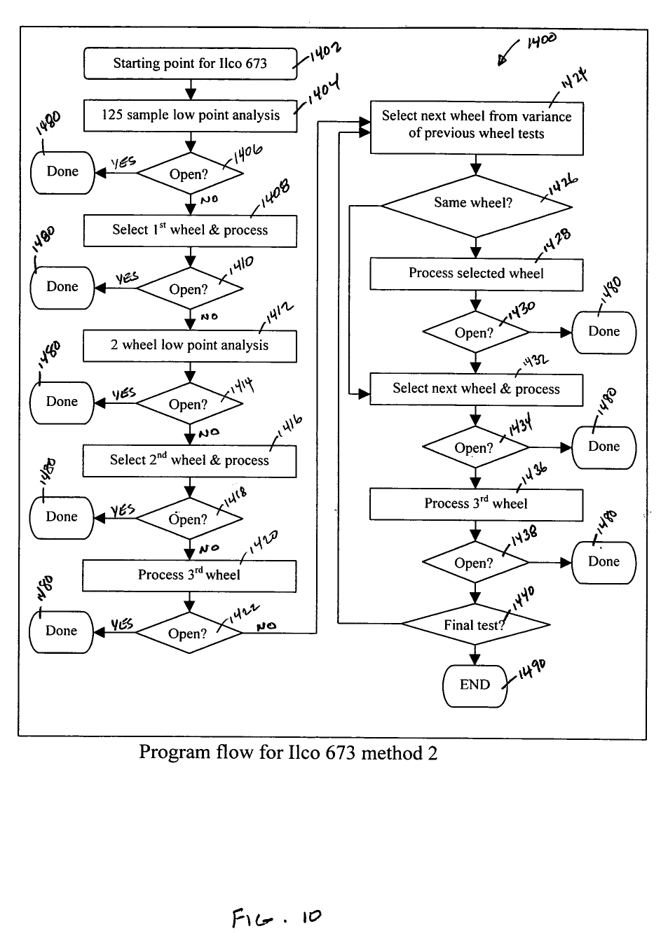

FIG. 12 illustrates an exemplary subroutine 1600 that may be employed to find the most probable gate location on a wheel. This subroutine begins with start 1602 where the data analysis routine 1600 is passed a matrix of data values. For the Group II approach, the data values are the contact point values, one row per data sample. The current program uses five data samples per dial position, so the data matrix has five rows, or five data vectors. Each column of the matrix represents a dial position.

Next, the probability vector is initialized in block 1604. The probability vector is equal in length to the data vector. Each element of the probability vector, like the data vector, refers to a unique sample position. Thus, each element in the probability vector represents the probability that the given sample position is the gate position. Each element in the probability vector is initialized to 1/n where n represents the number of sample positions in the data vector, i.e. the length of the data vector.

Thereafter, a vector and/or set of data samples is loaded in block 1606. Depending where the routine is in the process, this is where either the first set of data samples are loaded into the data vector or the next set of data samples is loaded into the data vector.

In order to do a probability analysis, a set of models is generated in block 1608 with the help of the data. The models are then compared against the data. The number of models is equal to the number of possible gate locations. In other words, there are n models, where n represents the number of elements in the data array. Thus each model represents the case that the gate is located at the given dial position associated with the respective element of the data vector. The following discussion explains the models utilized for each of the locks and methods discussed above. These discussions provide a framework for developing logic for other locks.

Generation of Models for the Group II Approach:

For the S&G 6730 Methods 1 and 2, the LaGard 3330 method 1, and the IIco 673 Methods 1 and 2, two models may be generated for each possible gate location. The reason two models can be generated for each possible gate location is that the data shows one type of profile in some cases and another type of profile in other cases. To be more specific, for the Group II locks, the fence typically drops in at two dial positions, rather than just a single dial position. Additionally, the fence will in some locks show a drop in three dial positions. This is due to the shape of the fence and its relation to the wheel upon which it rests. The bottom area of the fence that rests on the wheel(s) in some Group II locks can have a slight slope relative to the tangent of the circumference of the wheel at the point where the fence meets the wheel. When on one of the edges of the gate, this slope may allow the fence to drop slightly further than when the fence is not at the edge of the gate. Depending on how low the other two wheels are, this drop at the edge of a gate can be of the same order as the drop of the fence in its gate region. In this event, there are three dial positions that show a reduction in the contact point value relative to the other contact point values. For this reason the current program utilized both a two-drop model and a three-drop model. A separate probability analysis is done for each model. In the final probability vector, there is typically a peak associated with the candidate gate. The candidate gate is selected from the probability vector having the sharpest peak about its candidate gate.

To generate the two and three drop models, a 50 pass three point smooth is performed on the data vector and is stored in the two drop model vector and the three drop model vector. The smooth data serves as the background value for each of the two and three drop models. For the two-drop model, the minimum value of the data vector replaces two adjacent positions of the two-drop model vector. The gate position for this model is the element having the higher index, which relates to the larger of the two corresponding dial positions. For the three-drop model, the assumed gate position and both of its adjacent elements are replaced with the minimum value of the data vector. In this way models are developed for each of the possible gate positions.

For the LaGard 3330 method 2 approach, the background of the model is obtained in the same way as for the two and three drop models. The difference is that the model's gate is replaced by the maximum value of the data vector, and only one element is replaced. So for this case, the model is used to find a local maximum peak in the data. The reason for this is related to the shape of the wheels in newer LaGard 3330 locks. This makes it clear why the generation of models is important, and why it may be necessary to modify the model for other Group II locks.

It should be noted that the current approach taken in building the models is only one of many approaches. The models are only as good as the assumptions that are built into them. The models were kept simple, as the results obtained were sufficient to manipulate Group II locks discussed. Additionally, information regarding the wheel shapes, i.e. the wheel profiles, can be built into the models thereby increasing the accuracy of the models and improving the resulting candidate gate selection if required.

The model is then compared against the data in block 1610. This step involves computing the difference between the model and the conditioned data at the given dial position and storing a weighted result in the respective element of the intermediate probability vector. The intermediate probability vector will be discussed more fully below. A comparison between the data vector and the model vector is done for each of the models. In this way the intermediate probability vector, which contains elements for each possible gate position, is filled. The current mathematical process comparing the model against the data is to sum the difference between the elements of the data vector and the model vector. This sum is then weighted according to the variance of the data vector and the result is stored in the respective element of the intermediate probability vector. The weighting may be done by dividing the sum by twice the variance of the given data vector. In this way, data vectors having more scattered data will impact the final result less than data vectors having data that is less scattered.

Next, the result generated above is saved or stored in block 1612. At this point, the intermediate probability, i.e. the probability of the given model being the gate relative to the given data set, has been computed. This result is stored in its respective element of the intermediate probability vector.

Decision 1614 returns the program logic to block 1608 to generate the next model. When all elements of the intermediate probability vector have been computed, then the intermediate probability vector is factored into the probability vector in block 1616.

At this point, each of the models have been compared against the data in the previous data vector, and the intermediate probability vector has been computed. Now, the intermediate probability vector is factored into the probability vector. Three operations are accomplished in this stage of the data analysis routine 1600. First, the intermediate probability vector is normalized by dividing each of its elements by the element having the maximum value. This ensures that no overflow will occur in the next part. Second, each element of the intermediate probability vector is used to exponentially weight the respective element of the probability vector, thereby updating the probability vector. The following equation provides one example of this process for the ith element in the probability vector:
Probability[i]=Exp{−(lntermediate Probability[i])}*Probability[i]

The intermediate probability vectors, which represent the probability of candidate gates for each of the data vectors individually, are accumulated into the overall probability vector, which represents the probability of candidate gates based on all data vectors processed. In this way the probability vector is updated. The final step in this stage is to normalize the final probability vector. Thus, after having accumulated the resultant intermediate probabilities of all data vectors into the probability vector, and having normalized the probability vector, each element of the probability vector contains a number ranging from zero to one that represents the probability that the gate position associated with the given element is in fact the true gate, based on the data acquired and the models against which the data was compared. Thus, the data analysis routine is only as good as the models used. The index of the element of the probability vector having the maximum value represents the candidate gate value. It is this value that is returned from the data analysis routine.

After updating the probability vector in block 1616, subroutine 1600 may verify that all required data samples/vectors have been analyzed with decision 1618. If there is further data to be analyzed the program flow returns to block 1606 to load the next data vector. When the data analysis is complete, subroutine 1600 returns the index of the element of the probability vector having the maximum value the candidate gate position in return terminator 1620.

Block Diagram of Program Execution for the CM Approach

FIGS. 18-20 illustrate exemplary program logic for the CM approach. The CM lock has three wheels, and two cams. The first cam is positioned between the outermost wheel and the second cam. Its purpose is to hold the fence off the wheel pack when the second cam is in its drop region. As such, the first cam operates much as an ordinary wheel. It can be thought of as a fourth wheel that has a fixed gate region, i.e. its drop region is fixed. The drop regions of the cams are dependent on the orientation of the lock. For example, if the lock is oriented vertical down, the drop regions of first and second cams can be 25 and 75 respectively, while if the lock is right hand oriented, the cam locations would be 0 and 50 respectively.

FIG. 18 illustrates exemplary program logic for the main line program 2000. This logic begins with start 2002. Thereafter, the program may initiate a setup routine 2004. The setup routine gathers information about the locations of the cam drop regions. Additionally, the setup routine gathers information about the bolt-throw distance which enables the program 2000 to detect whether or not the lock has opened. The setup routine may also be where wheel park positions, i.e. the dial positions where the wheels are positioned for a given data sampling, are entered into the program.

After the program 2000 has completed the setup 2004 the lock is initialized in block 2006. The lock is initialized after the user sets the dial position of the lock to zero to give the program a point of reference from which it can keep track of the dial position. The lock initialization by computer 20 refers to turning the lock clockwise to pick up all the wheels. This step provides the program with a known state for each wheel. In the CM lock the lock is turned a minimum of five complete rotations clockwise.

Thereafter, program 2000 may determine the wheel to process in block 2008. This optional routine could be used to attempt to determine which wheel the fence is favoring in order to select that wheel as the first to test. One method could be to take data samples at a predetermined number of locations on each wheel independently and monitor the variation in the data for each wheel. The wheel having the greatest variation in the data could be an indication that the fence favors that wheel. Other approaches could also be defined. Selecting the wheel that the fence favors increases the chances of obtaining the gate for that wheel, and consequently increases the chances of obtaining the gates of underlying wheels as well. Experience has shown that the majority of locks tested are such that the outermost wheel is favored by the fence. Thus the current program forces the order in which the wheels are tested beginning from the outermost wheel, working inward to the innermost wheel. A reverse order program has also been built to account for locks showing a fence to wheel favoritism that begins with the innermost wheel.

After selecting the wheel to process in block 2008 the wheel process subroutine 2100 is called. This is the routine that actually gathers the data on the selected wheel and feeds the data to the analysis algorithm. The routine processes all necessary motor commands to park the untested wheels as well as parking the wheel under test through its dial positions. The routine returns the candidate gate position for use in the following wheel routines. Similar to the Group II approach the program checks for an open condition at each data point. This test is represented by decision 2010. If the lock opens the program exits and displays the combination.

The next wheel is then selected in block 2012 utilizing a forced order or an optional routine similar to the routine that determines the first wheel to test. In this case, however, the first wheel tested is parked at its candidate gate position. The program would then run a test that would determine which of the two remaining wheels is most likely in contact with the fence, i.e. which wheel the fence favors most. Again, one method of doing this would be to take data samples for each wheel independently at positions around the wheel, for example at 60-degree increments, while holding the other wheels at a fixed position. Analysis of the data for each wheel might show a greater variation in the data for one wheel over the other thus giving an indication as to which wheel should be selected to test next. Such a routine is not currently employed in the program, as a predetermined order in which to test the wheels has proven satisfactory.

The selected wheel is then processed with a wheel process routine 2100 and checked for a lock open with decision 2014. Thereafter, the remaining wheel is auto-dialed in block 2016. At this point the program has analyzed data for two wheels and consequently has candidate gate values for the two tested wheels. Remaining is the third wheel. It is faster to auto-dial the third wheel rather than to gather data and analyze the data for the third wheel in the current implementation. As long as the candidate gate positions for the first two wheels are correct, time is saved. Thus, this routine simply tries all dial positions of the untested wheel with the first two wheels at their respective candidate gate values. A lock opening is detected with decision 2018.

In the event that the lock fails to open the program 2000 proceeds to process the untested wheel with wheel process routine 2100. In the event that one or both of the candidates gate values for the first two wheels were incorrect, the lock would not have opened while auto-dialing the untested wheel. If the program proceeds to this routine, it will process the untested wheel with the first two wheels at their respective candidate gate positions. It would not be absolutely necessary to process the wheels in this order. One could choose to go back and re-test the first two wheels at this point and again auto-dial the untested wheel. Or one could choose to use other candidate gate values as determined from the first two wheel tests by some decision criterion. If the lock does not open at this point, as tested by decision 2022, the program either branches back to the point where the next wheel to process is determined, or if a predetermined number of passes through the process loop have already been executed, as tested by decision 2024, may end. When the lock opens the program 2000 may end as discussed above.

Details of the Wheel Analysis Routines for the CM Lock

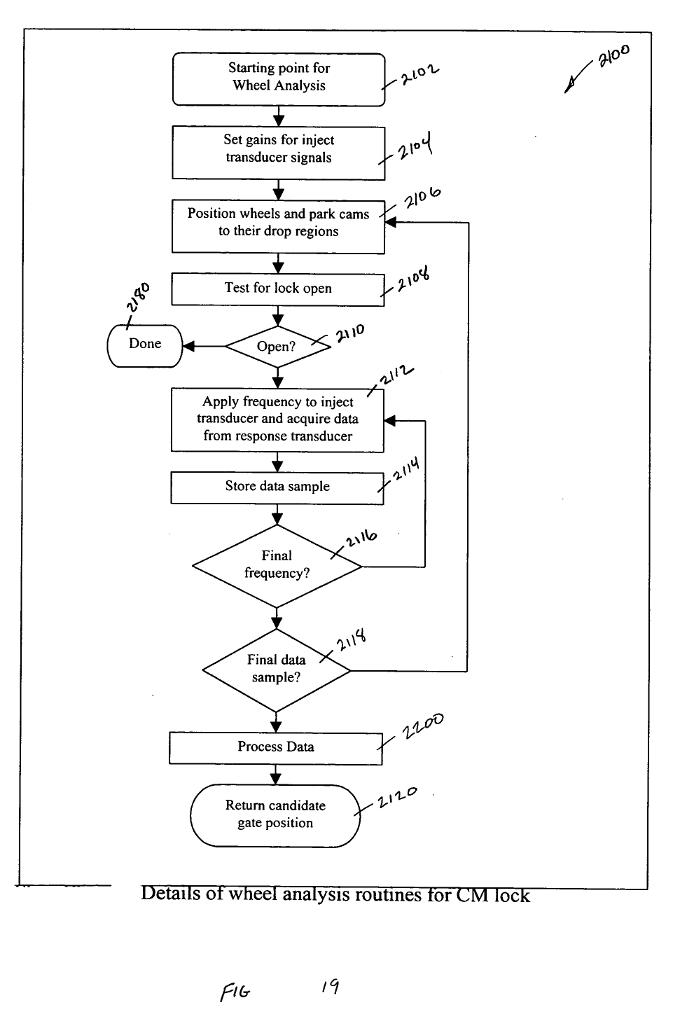

FIG. 19 illustrates an exemplary wheel process routine 2100. The illustrated routine begins at start 2102 knowing which wheel to analyze.

Next, the gains and frequencies for inject transducer signals may be set in block 2104. The inject transducer 56′ is used to inject frequencies into the lock via the dial 1. The amplitudes of the injected frequencies are set at this stage. The amplitudes are set to be high enough so as to acquire sufficient signal from the response transducer 52′ but low enough so that saturating the response signal is avoided. Typically, the gains are automatically set by routine 2100, but could be manually set if desired.

A range of 20 frequencies evenly spaced throughout the range of 1000 to 1600 Hz is used in the current program. Other frequency ranges could be utilized provided that a strong enough response signal is transmitted to the response transducer 52′. The gain is set for each of the injected frequencies. A range of frequencies is chosen as the key frequencies that enable a reading of the wheel gates can shift from lock to lock, and over other variables such as temperature and humidity and variations in the tolerances of the components of the lock itself.

The routine 2100 then positions the wheels and parks the cams in their drop regions in block 2106 utilizing motor system 30′. The wheels that are not being analyzed are given predetermined park positions. The wheel being analyzed is positioned at locations covering its circumference, and across the set of park positions for the other wheels that are not currently under analysis. This part of the routine sets up the wheels and cams for the next data sample.

Similar to the Group II approach the routine 2100 tests for a lock opening after positioning the wheels and cams with decision 2110. In the event that the current wheel park positions are in fact the combination of the lock, the program tries to open the lock at this point. If the lock opens, the combination has been determined and the program ceases execution with terminator 2180.

When the lock fails to open, one of the frequencies is applied and the response measured in block 2112. Here, the inject signal is applied to the inject transducer 56′ thereby exciting the lock at the given frequency. The response transducer 52′ is used to acquire data which measures of the response of the lock to the inject signal. A range of frequencies is used in the current algorithm ranging from 1000 to 1600 Hz

A total of 20 frequencies are used in the current program and they are spaced evenly across the above listed frequency range. A different number of frequencies and a different spacing could also be utilized with success.

At this point, a response waveform has been obtained from the response transducer 52′, for the frequency injected. The Fourier Transform of the waveform is taken via a Fast Fourier Transform (FFT) algorithm, and the magnitude of the FFT at the injected frequency is stored in block 2114. The FFT enables spurious input from external sources to be minimized in determining the magnitude of the response waveform at the injected frequency.

After the data is stored routine 2100 checks to verify that all required frequencies have been injected at decision 2116. If additional frequencies are to be injected, then program flow returns to block 2112 to inject the next frequency.

When samples have been obtained for each desired frequency the logic flow moves to decision 2118, where routine 2100 verifies that samples have been taken at all desired/required wheel positions. If further wheel positions are to be tested the routine returns to block 2106 to position the wheels.

At this point, all data samples have been acquired and converted to FFT magnitude values. What occurs in subroutine 2200 of the program is a probability analysis that operates on the data in order to determine the most probable gate position. As such, the most probable gate position is based on the data and the assumptions applied in the probability analysis. The probability routine is covered more fully below. When a gate candidate has been determined, it is passed back to the main program at return terminator 2120.

Data Analysis Routine for the CM Lock

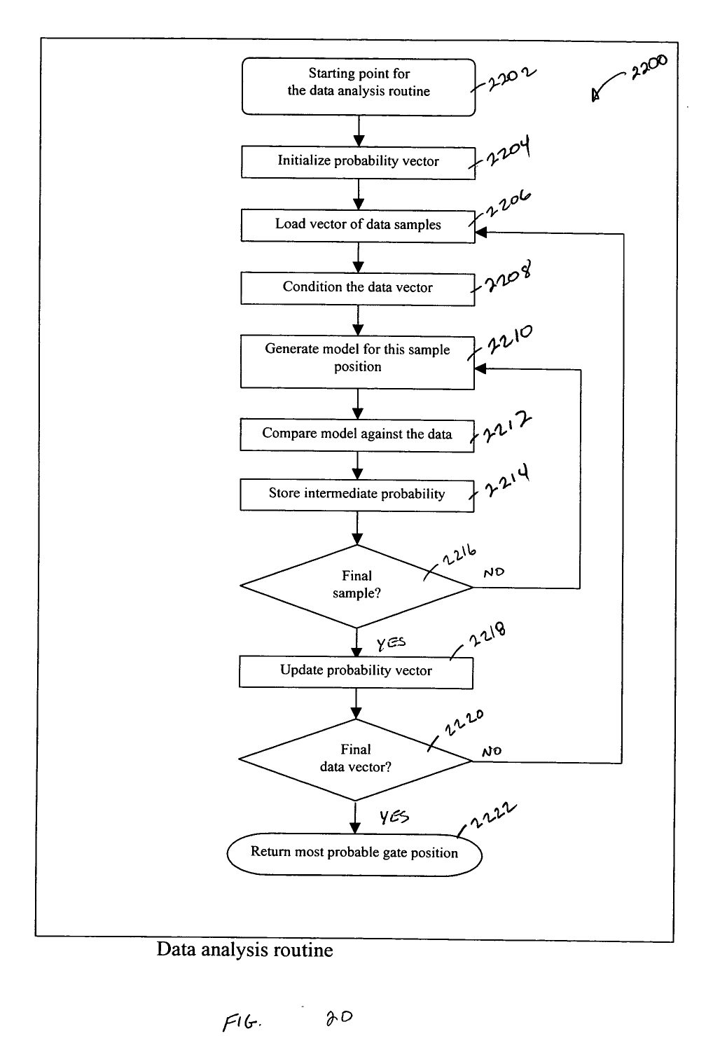

The exemplary data analysis routine 2200 illustrated in FIG. 20 is passed a matrix of data values. The data values in the case of the CM lock are the FFT magnitude values. The data can be thought of as a 2-D matrix of data values where the rows of the matrix can be thought of as vectors of data corresponding to a set of data samples across the circumference of the wheel tested, at a given frequency and a given set of wheel park positions for the untested wheels. Therefore, the number of rows in the data matrix depends on the number of frequencies injected as well as the number of pairs of park positions for untested wheels. For example, in the current program there are 20 frequencies and eight pairs of park positions for the untested wheels. This results in a data matrix having 160 (20×8) rows for each dial position tested. The number of elements in each row depends on the spacing of the sample locations across the tested wheel. In the current program four of the eight wheel tests cover the even dial positions while the other four-wheel tests cover the odd dial positions. This was done in order to save time.

The reason multiple tests per wheel are done is two-fold. First, the location of the untested wheel park positions can influence how much the fence favors the wheel under test. That is, for some sets of park positions, the untested wheels might cause the gate of the wheel under test to be masked. The phenomenon of masking occurs where the fence comes to rest on one or both of the untested wheels thus preventing it from coming to rest on the wheel under test. If this happens over a range of dial positions about the gate of the wheel under test, the gate for the wheel under test is effectively masked or hidden and characteristic change in the data at the gate position would not be realized. For this reason multiple pairs of park positions for the untested wheels are used.

The second reason why multiple wheel tests are done for the wheel under test is that the data for any one of the wheel tests may not show the gate, or may be insufficient to firmly establish a candidate gate for that wheel. It was found that by accumulating the results for a number of wheel tests, the gate region would show up more prominently. This is due to the fact that the change in the data in the gate region, if the gate was not masked, is typically a small but consistent change. Thus, by accumulating the results from a number of wheel tests, the effect of the change of the data in the gate region also accumulated in an additive fashion thereby establishing the candidate gate value more effectively. The current embodiment conducts eight tests per wheel. It is not absolutely necessary, however, that eight tests be run per wheel. But it was determined through experimentation that eight tests resulted in the ability to routinely bring out the location of the gate.

The matrix of data values for the CM lock differ from the data matrix for the approach taken in the manipulation of Group II locks. The data for the CM lock, as mentioned above, are FFT magnitude values. The data for the Group II locks are contact point, i.e. “click” values. The “click” refers to the point of contact between the fence nose and the cam of the Group II lock. By starting from a fixed reference position and moving toward the contact point at a known acceleration and velocity, the time to the contact point will give a measure of how high or how low the fence is on the wheel (or wheels) upon which it rests. Because the contact point values used in the Group 11 approach show the gate more definitively, only a single test per wheel is required. In addition, the contact point values are generated within the lock as a consequence of dial rotation, so there is no need for injecting signals into the lock. Thus, the data “matrix” for the Group II approach is really a single row of data, i.e. a single data vector. Again, the number of elements in the data vector correspond to the locations at which data are sampled on the given wheel. The current approach for Group II locks is to take data at every dial position. This was to help ensure the robustness of the approach. It would save time, albeit at the potential expense of robustness, to take samples every other or every 1.5 dial positions. So for the Group II approach, only a single wheel test is done resulting in a single data vector of “click” values, whereas in the CM approach, the data matrix consists of a number of FFT magnitude data vectors. The number of data vectors depends on the number of injected frequencies and the number of untested wheel park position pairs.

FIG. 20 provides an illustrative flowchart for an exemplary data analysis subroutine 2200. The subroutine shown begins at start 2202.

Thereafter, subroutine 2200 initializes the probability vector in block 2204. The probability vector is equal in length to the data vector. Each element of the probability vector, like the data vector, refers to a unique sample position. Thus each element in the probability vector represents the probability that the given sample position is the gate position. Each element in the probability vector is initialized to 1/n where n represents the number of sample positions in the vector, i.e. the length of the vector.

Data samples are then loaded in block 2206. Depending where the routine is in the process, this is where either the first set of data samples are loaded into the data vector or the next set of data samples are loaded into the data vector.

The FFT magnitude data values are not used directly in the data analysis routine for the CM approach. The FFT magnitude data is first conditioned in block 2208 in order to enable the generation of a suitable set of models, which will be compared with the conditioned data. The reason for this will become clear in the following discussion. The “click” values used in the Group II approach is not conditioned but are used directly in their data analysis routine 1600.

Each of the data vectors in the matrix of FFT magnitude values are conditioned. Conditioning the data first involves running a smooth on the FFT magnitude data and storing the result in another data vector, the smoothed data vector. A five-point smooth is currently employed, but it is expected that larger or smaller numbers of points could also be utilized. Next, each element in the data vector is replaced with the absolute value of the difference between the data vector element and the smooth vector element. In this way a new data vector is obtained that holds the absolute value of the difference between the elements of the original data vector and the elements of the smoothed data vector. The reason this is done is two-fold.

First, the FFT magnitude data tends to have trends. That is, the FFT magnitude data may follow a positive slope, trending upward or may follow a downward slope, trending downward, or may consist of any combination of such trends. By taking the absolute value of the difference between the original FFT magnitude data and the smooth version of that data, the trending of the data is minimized.

Second, the change in the gate region can manifest itself in either an increase or a decrease in the FFT magnitude. Thus, by taking the absolute value of the difference between the original FFT magnitude data and the smooth version of that data, both a local increase in the data and a local decrease in the data are registered as a local rise in the conditioned data.

Finally, the minimum value is subtracted off of each element in the vector so that the conditioned data values are referenced to zero. The reason for this will become clear in the description of the generation of the models for the CM approach. In this way, a conditioned data vector replaces each of the original FFT magnitude vectors.

In order to do a probability analysis, a set of models are generated in block 2210 with the help of the data, and are compared against the data. The number of models is equal to the number of possible gate locations. In other words, there are n models, where n represents the number of elements in the data array. Thus each model represents the case that the gate is located at the given dial position associated with the respective element of the data vector. For the CM approach, only a single model is considered for each sample position.

Recall that the FFT magnitude data tended to show either an increase or a decrease in the gate region. To clarify this, it was seen that for some frequencies there was a local increase in the FFT magnitude at the gate region, while for other frequencies there was a local decrease. That is why the absolute value of the difference between the original FFT magnitude data and the smoothed version of that data was taken. The models are an idealization of what the data might look like if the gate position is in fact at the location the model assumes.

At this point, each data vector corresponds either to all even sample positions or to all odd sample positions. Thus, at this point there may be 50 data elements in the data vector. For purposes of the data analysis routine 2200, however, the data vectors are expanded into 100 element vectors. In this way, the “odds” vectors and the “evens” vectors can both be fed into the same data analysis routine. The missing elements are filled with zeros. That is, for the even data vectors, the odd dial position elements are filled with zeros, and vice versa for the odd data vectors. This is the reason why the minimum value of the absolute value of the difference between the FFT magnitude and the smoothed value was subtracted from each element of the data vector.

To generate a model, the maximum value of the conditioned data vector replaces the element of the model vector corresponding to the assumed gate location for that model. Thus, a model vector, equal in length to the data analysis vector is generated. And a set of model vectors is generated for each of the possible gate locations for the data vector. The reason why the models are generated in the above fashion becomes clear when the data analysis routine is described below.

It should be noted that the current approach taken in building the models is only one of many approaches. The models are only as good as the assumptions that are built into them. The models were kept simple, as the results obtained were sufficient to manipulate the CM and Group II locks. However, as more information regarding the wheel shapes, i.e. the wheel profiles, becomes available, this information, if it is relevant, can be built into the models thereby increasing the accuracy of the models and improving the resulting candidate gate selection.

Next, the conditioned data is compared to a model in block 2212. This step involves computing the difference between the model and the conditioned data at the given dial position and storing a weighted result in the respective element of the intermediate probability vector. The intermediate probability vector will be discussed more fully in the next stage of the flow chart. A comparison between the data vector and the model vector is done for each of the models. In this way the intermediate probability vector, which contains elements for each possible gate position, is filled. The actual mathematical process of the comparison of the model against the data is to sum the difference between the elements of the data vector and the model vector. This sum is then weighted according to the variance of the data vector and the result is stored in the respective element of the intermediate probability vector. The weighting is done by dividing the sum by twice the variance of the given data vector. In this way, data vectors having more scattered data will impact the final result less than data vectors having data that is less scattered.

At this point, the intermediate probability, i.e. the probability of the given model being the gate relative to the given data set, has been computed. This result is stored in its respective element of the intermediate probability vector in block 2214. Thereafter, subroutine 2200 checks that the conditioned data has been compared to all models generated for this data vector. If the data has not been compared to all the models generated the routine returns to block 2210 to generate the next model.

When all elements of the intermediate probability vector have been computed, then the intermediate probability vector is factored into the probability vector in block 2218. At this point, each of the models have been compared against the data in the previous data vector, and the intermediate probability vector has been computed. Now, the intermediate probability vector is factored into the probability vector in block 2218. Three operations are accomplished in this stage of the data analysis routine. First, the intermediate probability vector is normalized by dividing each of its elements by the element having the maximum value. This ensures that no overflow will occur in the next part. Secondly, each element of the intermediate probability vector is used to exponentially weight each respective element of the probability vector, thereby updating the probability vector. The following equation gives one representation of this process for the ith element in the probability vector:
Probability[i]=Exp{−(Intermediate Probability[i])}*Probability[i]

The intermediate probability vectors, which represent the probability of candidate gates for each of the data vectors individually, are accumulated into the overall probability vector, which represents the probability of candidate gates based on all data vectors processed. In this way the probability vector is updated. The final step in this stage is to normalize the final probability vector. Thus, after having accumulated the resultant intermediate probabilities of all data vectors into the probability vector, and having normalized the probability vector, each element of the probability vector contains a number ranging from zero to one that represents the probability that the gate position associated with the given element is in fact the true gate, based on the data acquired and the models against which the data was compared. Thus, the data analysis routine 2200 is only as good as the models used. The index of the element of the probability vector having the maximum value represents the candidate gate value. It is this value that is returned from the data analysis routine.

Decision 2220 verified that all data samples have been processed. If the data analysis is not complete the routine returns to block 2206 to load the next data sample/vector.

The index of the element of the probability vector having the maximum value represents the candidate gate value. It is this value that is returned from the data analysis routine at return terminator 2222. The probability analysis in the data analysis routine determines which of the models best describes the data. As each of the models corresponds to a gate prediction, the outcome of the probability analysis corresponds to the best prediction of the gate based on the given data and models. Thus, it is conceivable that the current models could be improved upon, and that future models could be generated that are specific to a given lock type and/or various versions of a given lock type.

In summary, numerous benefits have been described which result from employing the concepts of the invention. The foregoing description of an exemplary preferred embodiment to the invention has been presented for the purpose of illustration and description. It is not intended to be exhaustive or to limit the invention to the precise form disclosed. Obvious modifications or variations are possible in light of the above teachings. The embodiment was selected and described in order to best illustrate the principles of the invention and its principal application to hereby enable one of ordinary skill in the art to best utilize the invention in various embodiments and with various modifications as are suited to the particular use contemplated It is intended that the scope of the invention be defined by the claims appended hereto.

1. A device for opening a lock comprising:
a computer;
a motor, the motor rotating a dial of the lock, operation of the motor is controlled by the computer;
an inject transducer connected to the computer and transmitting a sound signal to the lock;
a sensor providing the computer a signal that provides information about the lock's response to the transmitted sound signal;
an analysis program loaded on the computer, the program analyzing the information provided to the computer by the sensor to determine the combination for the lock.

2. A method for opening a lock comprising:
positioning wheels of the lock to a test position;
transmitting a sound signal to the lock;
detecting the lock's response to the transmitted sound signal;
storing a data sample representative of the response;
repeating the above steps until sufficient data has been collected to model the lock;
analyzing the stored data to obtain the opening combination for the lock.

3. A device for opening a lock comprising:
positioning means for positioning wheels at the lock to a test position:
transmitting means for transmitting a sound signal to the lock;
detection means for detecting the lock's response to the transmitted sound signal;
storing means for storing a data sample representative of the response; and
analyzing means for analyzing the stored data to obtain the opening combination for the lock.
